(19) United States
(12) Patent Application Publication
(10) Pub. No.: US 2024/0318947 A1
(43) Pub. Date: Sep. 26, 2024

(54) ARTICULATED HEAD

(71) Applicant: RENISHAW PLC, Gloucestershire (GB)

(72) Inventors: Benjamin George HOY, Wotton-under-Edge (GB); Andrew Geoffrey BUTTER, Wotton-under-Edge (GB)

(73) Assignee: RENISHAW PLC, Wotton-under-Edge, Gloucestershire (GB)

(21) Appl. No.: 18/277,697

(22) PCT Filed: Feb. 16, 2022
(86) PCT No.: PCT/GB2022/050412

§ 371 Date: Aug. 17, 2023

(30) Foreign Application Priority Data
Feb. 17, 2021 (GB) 2102199.3
Feb. 17, 2021 (GB) 2102200.9
Feb. 17, 2021 (GB) 2102201.7

(51) Int. Cl. G01B 5/008

(52) U.S. Cl. CPC G01B 5/008

(57) ABSTRACT

An articulated head for facilitating reorientation of a mounted tool, including: a first member for mounting the head on a positioning apparatus; a second member coupled to the first so its orientation relative thereto about a first axis can be changed between, and locked at predefined orientations, the members can be unlocked by separating the members along the first axis for reorientation of the second member about the first axis; a third member coupled to the second so its orientation relative thereto about a second axis can be changed between, and locked at predefined orientations, the second and third members can be unlocked by separating the members along the second axis for reorientation of the third member about the second axis, the first and second axes are not parallel; and a powered mechanism independently controlling separation of the first and second and the second and third members.

The present invention relates to an articulated head, in particular one used in a metrology apparatus. For example, the invention relates to an indexed articulated head which is configured to support a measurement probe on a coordinate positioning apparatus such that the measurement probe can be arranged at a plurality of different rotational orientations.

As is well known in the field of coordinate positioning apparatus, in particular in the field of coordinate measuring machines (CMMs), an articulated head (or rotary table) for a measurement probe (or object) comprises rotatable/articulatable/reorientable members which facilitate reorientation of a measurement probe (or object) mounted thereon about at least one axis of rotation. Typically, an articulated head will provide two orthogonal axes of rotation, although it is possible that fewer or more axes of rotation are provided.

US5185936 describes an articulated head with one axis of rotation and EP2889573, US7213344 and WO2006/079794 describe articulated heads which provide two orthogonal axes of rotation. As described in these documents, it is also known to provide articulated heads with an indexing mechanism which enable the relatively rotatable parts of the articulated head to be locked into a defined, indexed position. Indexing mechanisms can be provided by providing two sets of intermeshing members, one on each of the relatively rotatable/articulatable members of the articulated head. When the intermeshing members are engaged, they lock so as to prevent relative rotation of the rotatable members. When the intermeshing members are disengaged, the rotatable members are free to rotate relative to each other such that they (and a measurement probe mounted thereon) can be repositioned to a new orientation before being reengaged so as to lock the rotatable members (and a measurement probe mounted thereon) at the new orientation. A measurement operation can then take place with the measurement probe being held at a defined, known, rotational orientation.

The present application describes an improved arrangement for locking and unlocking multiple axes of an indexed articulated head.

According to a first aspect of the invention, there is provided an articulated head for facilitating the reorientation of a tool mounted thereon (about first and second axes of rotation), the articulated head comprising: a first member for mounting the articulated head on a positioning apparatus; a second member coupled to the first member such that its orientation (in other words, rotational position/configuration) relative to the first member about a first axis can be changed between, and locked at one of, a plurality of predefined indexable orientations (rotational positions about the first axis), wherein the first member and second member can be unlocked by separating the first member and second member along the first axis so as to thereby enable reorientation (rotation) of the second member relative to the first member about the first axis; a third member coupled to the second member such that its orientation (in other words, rotational position/configuration) relative to the second member about a second axis can be changed between, and locked at one of, a plurality of predefined indexable orientations (rotational positions about the second axis), wherein the second member and third member can be unlocked by separating the second member and third member along the second axis so as to thereby enable reorientation (rotation) of the third member relative to the second member about the second axis, wherein the first and second axis are not parallel; and at least one powered mechanism for controlling the separation of the first member and second member along the first axis and the separation of the second member and third member along the second axis, configured such that the separation of the first member and second member, and the separation of the second member and third member, can be controlled independently of each other.

In accordance with the present invention, the locking/unlocking of the first and second axes can be controlled/actuated independently of each other (in other words, “individually”). Accordingly, for example, the articulated head could be operated so as to unlock the first axis but keep the second axis locked, or vice versa. Of course, such a configuration does not preclude the first and second axes being unlocked together/simultaneously, but an articulated head configured in accordance with the present invention provides the ability to unlock/lock the different axes of the head separately/independently of each other (i.e. they don't have to both be unlocked at the same time). As well as enabling a reduction of the load on the/each powered mechanism (e.g. motor), (which can provide benefits in terms of heat generation, electrical power consumption, the required size of powered mechanism, etc), notably the present invention reduces unnecessary unlocks of an axis. Not only can this reduce unnecessary wear, but the act of unlocking and relocking an axis can lead to repeatability errors (due to the members not reseating in exactly the same place as before) and therefore inaccuracies in the positioning of the tool mounted on the articulated head. Accordingly, an articulated head according to the present invention can provide improved positioning control of a tool mounted thereon, and therefore can provide improved metrology.

The at least one powered mechanism can comprise at least one (“lock”) motor. In an advantageous embodiment of the invention, the at least one powered mechanism comprises a first (“lock”) motor for controlling the separation of the first member and second member along the first axis, and a second (“lock”) motor for controlling the separation of the second member and third member along the second axis. Accordingly, the first and second (“lock”) motors can be independently operable.

The at least one powered mechanism could be contained/housed within the second member. The first and second (“lock”) motors could be contained/housed within the second member. This can help to provide a compact head configuration. Accordingly, the at least one powered mechanism (e.g. both the first and second “lock” motors) could be configured to rotate with the second member as it rotates relative to the first member about the first axis.

The articulated head could comprise at least one (“drive”) motor for effecting reorientation/rotation of the relatively reorientable members, e.g. for effecting reorientation/rotation of the first and second members and/or for effecting reorientation/rotation of the second and third members. The articulated head could comprise a first (“drive”) motor for effecting reorientation/rotation of the second member relative to the first member about the first axis when the first member and the second member are unlocked, and a second (“drive”) motor for effecting reorientation/rotation of the third member relative to the second member about the second axis when the second and third members are unlocked. The at least one (“drive”) motor, e.g. the first and second (“drive”) motors could, be housed within the second member. This can help to provide a compact head configuration. Accordingly, the at least one (“drive”) motor, e.g. the first and second (“drive”) motors, could be configured to rotate with the second member as it rotates relative to the first member about the first axis.

As will be understood, the term “powered mechanism” is used to mean that the separation of the members (e.g. of the first and second members, or of the second and third members) is not manually operated/controlled. Accordingly, for example, the at least one powered mechanism could comprise an electrically powered, pneumatically, powered or hydraulically powered mechanism/motor. Accordingly, there could be a power source for the powered mechanism. The power source for the powered mechanism could reside/be provided by, the articulated head (e.g. the power source could comprise a battery residing in the articulated head), or could reside/be provided externally from the articulated head (e.g. and supplied to the articulated head via wires). Preferably, the at least one powered mechanism comprises an electrically powered mechanism. For example, in an advantageous embodiment of the invention, the at least one (e.g. the first and second) “lock” motor(s) could comprise an electric motor. Similarly, the at least one (e.g. first and second) drive motor(s) could comprise an electric motor.

The first and second axes could be substantially orthogonal.

The articulated head could comprise a tool mount for the removable mounting of a tool thereon. The articulated head could comprise a two-axis articulated head. Accordingly, the third member can comprise said tool mount. In the case of a three-axis head, there could be a fourth member, coupled to the third member such that its orientation relative to the third member about a third axis can be changed between, and locked at one of, a plurality of predefined indexable orientations. In such an embodiment, the fourth member could comprise said tool mount. In such an embodiment, the first, second and third axes could be mutually orthogonal.

The tool mount could form one part of a kinematic mount, the other part of the kinematic mount being provided by the tool to be mounted thereon. As will be understood a kinematic mount is one which has elements on one part which are arranged to cooperate with elements on another part to provide highly repeatable positioning. The elements are arranged to cooperate with each other so as to constrain relative movement between the parts in all six degrees of freedom (i.e. three perpendicular linear degrees of freedom and three perpendicular rotational degrees of freedom) preferably by six points of contact or constraints. In one particular embodiment, the elements on one of the parts can be arranged to provide a pair of mutually converging surfaces at each of three spaced locations, in such a manner as to provide a total of six points of contact with the elements on the other part. This constrains the six possible degrees of freedom of one part relative to the other. Such a kinematic mount is sometimes known as a Boys support, and is described in, for example, H. J. J. Braddick, “Mechanical Design of Laboratory Apparatus”, Chapman and Hall, London, 1960, pages 11-30. Further details of example configurations for providing such kinematic location/connection is provided below.

The tool mount could comprise one or more magnets for magnetically retaining a tool mounted thereon.

Suitable tools for mounting on the articulated head include measurement probes. Suitable measurement probes include probes for measuring the dimensions of a workpiece. Suitable measurement probes could be contact or non-contact measurement probes. Suitable measurement probes include touch-trigger and also scanning or “analogue” measurement probes.

The indexing increment of the first and second members, and/or of the second and third members, can be 10° or less, for instance 5° or less, for example 4° or less. The indexing increment of the first and second members, and/or of the second and third members, could be at least 0.5°, for instance at least 1°. For example, the indexing increment of the first and second members, and/or of the second and third members, could be about 2.5°.

The first member and second member could provide a first pair of cooperating sets of mutually engageable engagement elements/features which can be locked together in a plurality of different angular orientations about the first axis so as to provide said predefined indexable orientations. The second member and third member could provide a second pair of cooperating sets of mutually engageable engagement elements/features which can be locked together in a plurality of different angular orientations about the second axis so as to provide said predefined indexable orientations. As will be understood, a pair of cooperating sets of mutually engageable engagement elements can comprise two sets of intermeshing members/features, one on each of the members. For example, the first pair of cooperating sets of mutually engageable engagement elements can comprise, an annular series of features, for example a series of balls, or a series of tapered teeth (e.g. providing a face spline member) on one of the first and second members (e.g. on the first member). The other of the first and second members (e.g. the second member) could also comprise an annular series of features, although it can be preferred that the engagement elements of the other of the first and second members (e.g. the second member) are configured, such that when in the locked state, they engage with only a subset of the series of teeth of the annular series of features on said one of the first and second members (e.g. on the first members) at a plurality of discrete, annularly-spaced, locations.

A pair of cooperating sets of mutually engageable engagement elements/indexing mechanism can be configured to provide a kinematic location/connection therebetween.

The articulated head could comprise a first prop which is actuatable by the at least one powered mechanism between a retracted configuration at which the first member and second member are in their locked state, and an extended configuration at which the first member and the second member are held apart by the first prop along the first axis such that the first member and second member are unlocked. The second member could comprise/house the first prop. The first prop could be coupled to the first member (e.g. via corresponding engagement features as described in more detail below) when in its extended configuration and decoupled from the first member when in its retracted configuration.

The articulated head could comprise a second prop which is actuatable by the at least one powered mechanism between a retracted configuration at which the second member and the third member are in their locked state, and an extended configuration at which the second member and the third member are held apart by the second prop along the second axis such that the second and third members are unlocked. The second member could comprise/house the second prop. The second prop could be coupled to the third member (e.g. via corresponding engagement features as described in more detail below) when in its extended configuration and decoupled from the third member when in its retracted configuration.

The first prop could be axially driven between its extended and retracted configurations by a first lever which is actuated by the at least one powered mechanism. The second member could comprise/house the first lever. The second prop could be axially driven between its extended and retracted configurations by a second lever which is actuated by the at least one powered mechanism. The second member could comprise/house the second lever.

The first lever could be pivotally mounted toward its first end to a first flexure which is anchored to the second member, and attached toward its second end to the at least one powered mechanism which is configured to raise and lower second end of the first lever. The first lever could be attached at a point between its first and second ends to the first prop. The second lever could be pivotally mounted toward its first end to a second flexure which is anchored to the second member, and attached toward its second end to the at least one powered mechanism which is configured to raise and lower second end of the first lever. The second lever could be attached at a point between its first and second ends to the second prop.

The first and second members could be magnetically biased toward each other so as to retain the first and second members together. The second and third members could be magnetically biased toward each other so as to retain the second and third members together.

The first prop and the first member could be magnetically biased toward each other so as to at least aid retention of the first member and second member, at least when they are in an unlocked configuration. The second prop and the third member could be magnetically biased toward each other so as to at least aid retention of the second member and third member, at least when they are in an unlocked configuration.

The articulated head could further comprise at least one supplemental bias member configured to bias the first prop towards its retracted configuration. The articulated head could further comprise at least one supplemental bias member configured to bias the second prop towards its retracted configuration. The articulated head could further comprise at least one first supplemental bias member configured to bias the first prop towards its retracted configuration. The articulated head could further comprise at least one second supplemental bias member configured to bias the second prop towards its retracted configuration. The at least one (first and/or second) supplemental bias member could comprise magnetic material, for example a magnet. The first prop, the first member and the second member could comprise magnetic material arranged so as to provide: i) magnetic forces acting on the first prop which urge the first prop toward its extended configuration; and ii) magnetic forces acting on the first prop which urge the first prop toward its retracted configuration. The second prop, the second member and the third member could comprise magnetic material arranged so as to provide: i) magnetic forces acting on the second prop which urge the second prop toward its extended configuration; and ii) magnetic forces acting on the second prop which urge the second prop toward its retracted configuration.

The positioning apparatus could comprise a coordinate positioning apparatus, for example a coordinate measuring machine (CMM). The coordinate positioning apparatus, e.g. the CMM, could be a Cartesian coordinate positioning apparatus, i.e. which comprises two or three linearly moveable members arranged in series, each one moveable along a linear axis which is orthogonal to the others, so as to provide for movement of the articulated head mounted there on in two or three mutually orthogonal dimensions, e.g. X, Y and Z. Accordingly, the positioning apparatus could be configured to facilitate repositioning of the articulated head in at least two, for example, three orthogonal linear degrees of freedom. The articulated head could be removably mounted to the positioning apparatus (e.g. to a z-column or a quill of a CMM) via one or more releasable fasteners, such as one or more bolts. Typical Cartesian coordinate positioning apparatus include Bridge, Portal, Cantilever, Horizontal Arm, and Gantry type machines.

According to another aspect of the invention there is provided an apparatus, in particular a positioning apparatus, comprising an articulated head as described above mounted thereon. Accordingly, the first member of the articulated head could be mounted on the positioning apparatus, e.g. via one or more releasable fasteners. The apparatus can comprise at least one electronic controller configured to control/operate of the at least one powered mechanism (so as to thereby control the separation of the first and second members, and/or the second and third members of the articulated head). Optionally, the same or another controller could be configured or provided to control/operate at least one drive motor for controlling the relative orientation of the first and second member and/or second and third member, when they are unlocked.

According to another aspect of the invention there is provided, a method of operating an articulated head as described above, which is mounted on a positioning apparatus, the method comprising: i) operating the at least one powered mechanism so as to cause unlocking of the first and second members whilst keeping the second and third members locked, relatively rotating the first and second members about the first axis to a new rotational position, and then operating the at least one powered mechanism so as to cause locking of the first and second members at the new rotational position; or ii) operating the at least one powered mechanism so as to cause unlocking of the second and third members whilst keeping the first and second members locked, relatively rotating the second and third members about the second axis to a new rotational position, and then operating the at least one powered mechanism so as to cause locking of the second and third members at the new rotational position.

Embodiments of the invention will now be described, by way of example only, with reference to the following drawings, in which:

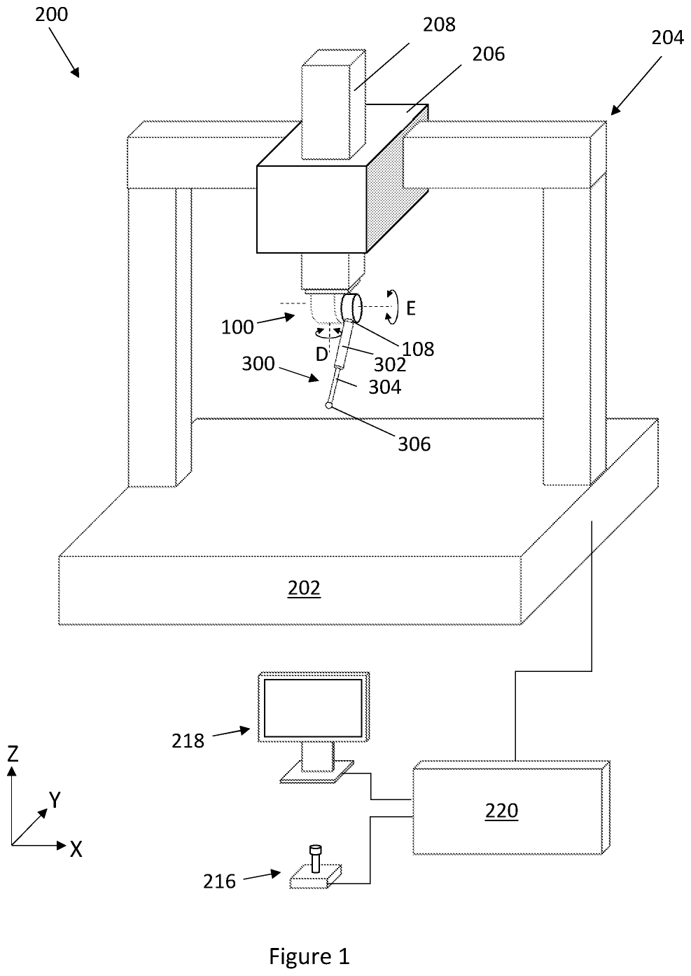

FIG. 1 illustrates an indexing head according to the present invention mounted on a coordinate measuring machine (CMM);

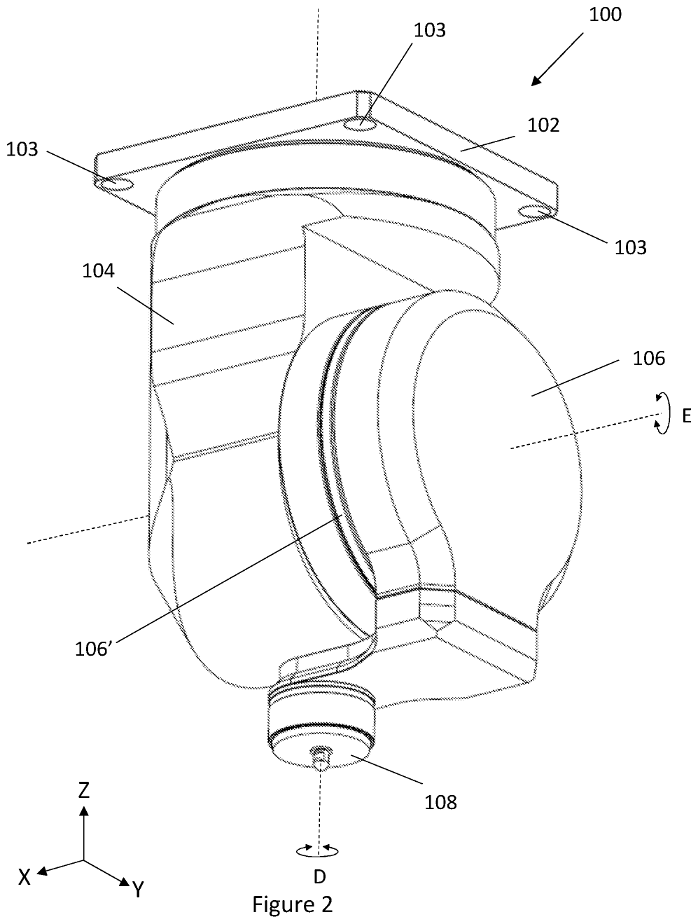

FIG. 2 illustrates the indexing head of FIG. 1 in isolation;

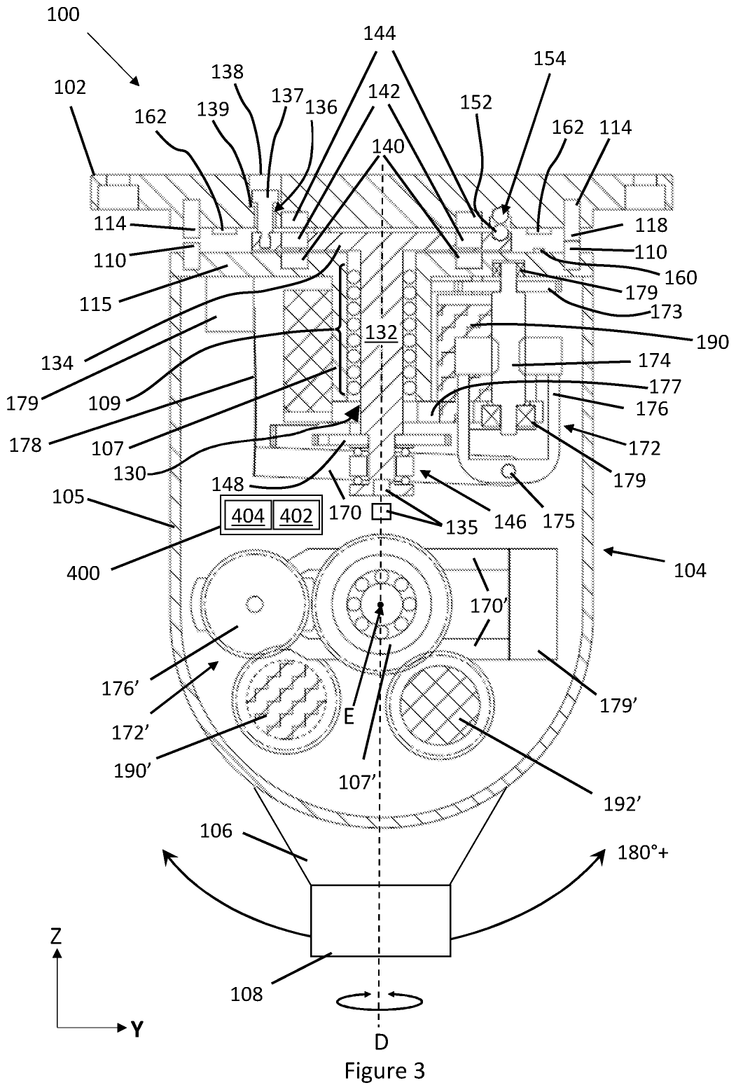

FIG. 3 illustrates a cross-sectional view of the indexing head of FIG. 1 when in its locked configuration;

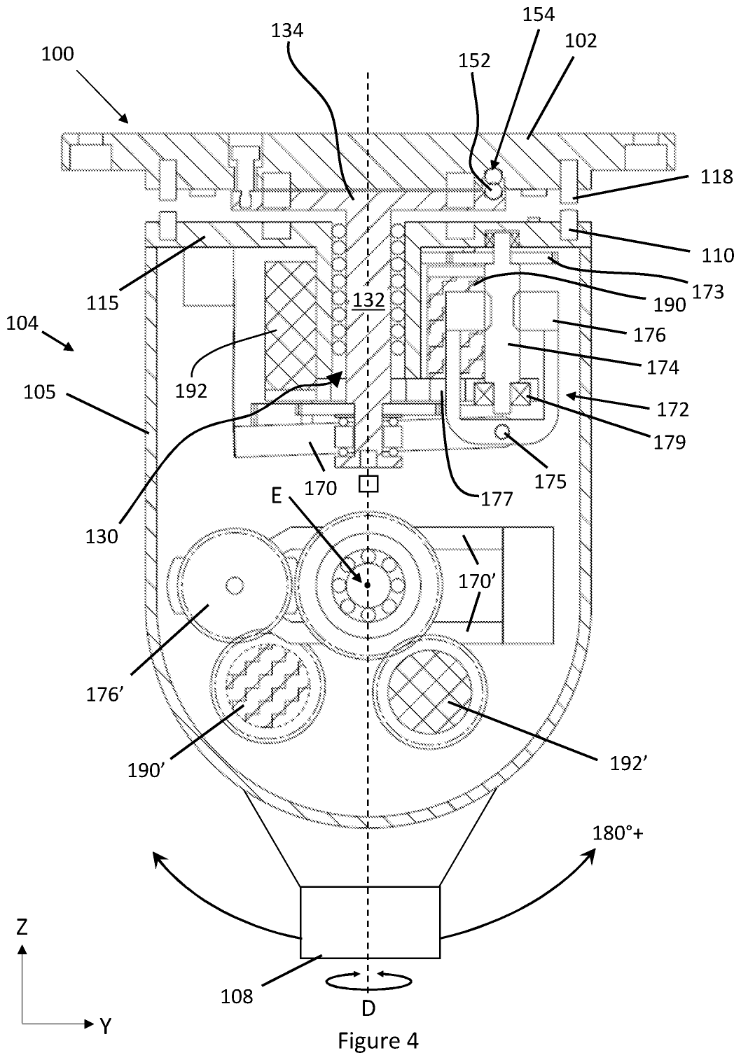

FIG. 4 illustrates a cross-sectional view of the indexing head of FIG. 1 when in its unlocked configuration;

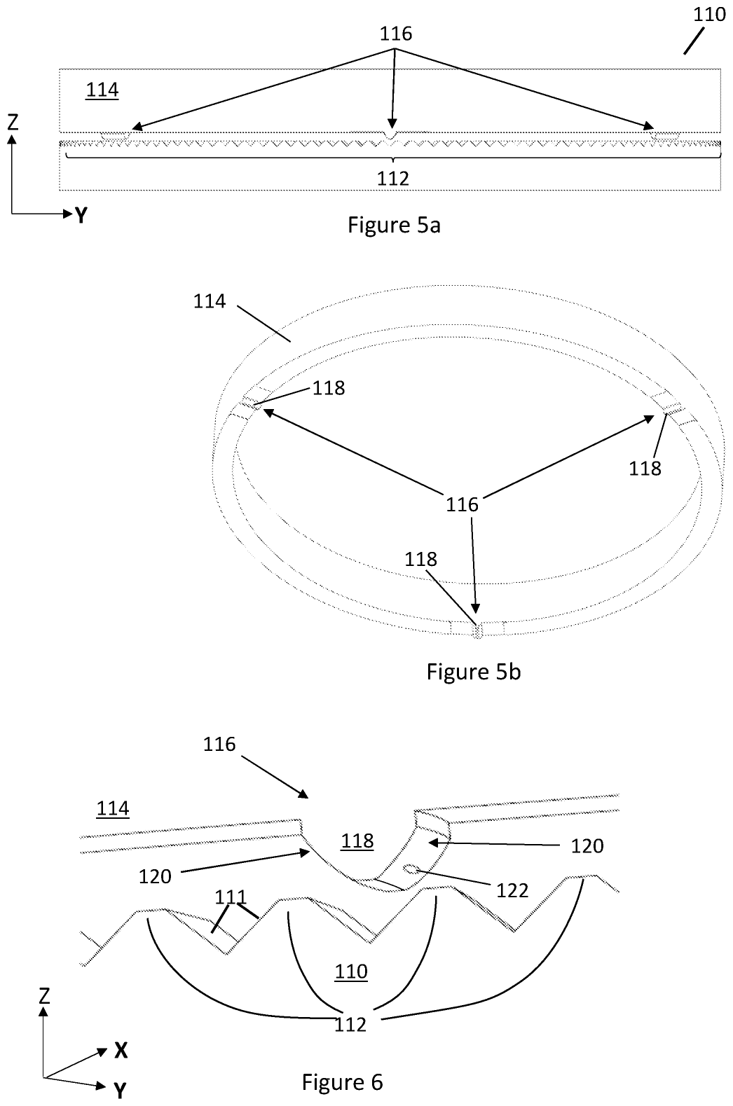

FIG. 5a illustrates the indexing mechanism of the indexing head of FIG. 1;

FIG. 5b illustrates one part of the indexing mechanism of FIG. 5a in isolation;

FIG. 6 is a detail view of the indexing mechanism shown in FIG. 5a;

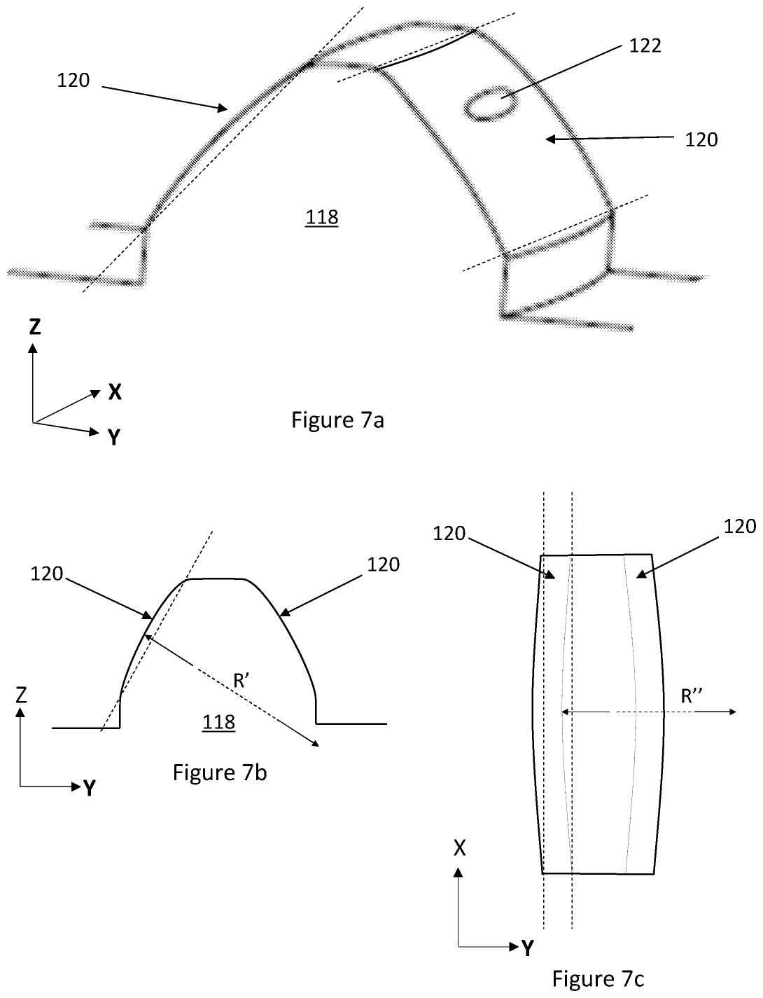

FIGS. 7a, 7b and 7c illustrate a single tooth of the part of the indexing mechanism shown in FIG. 5b;

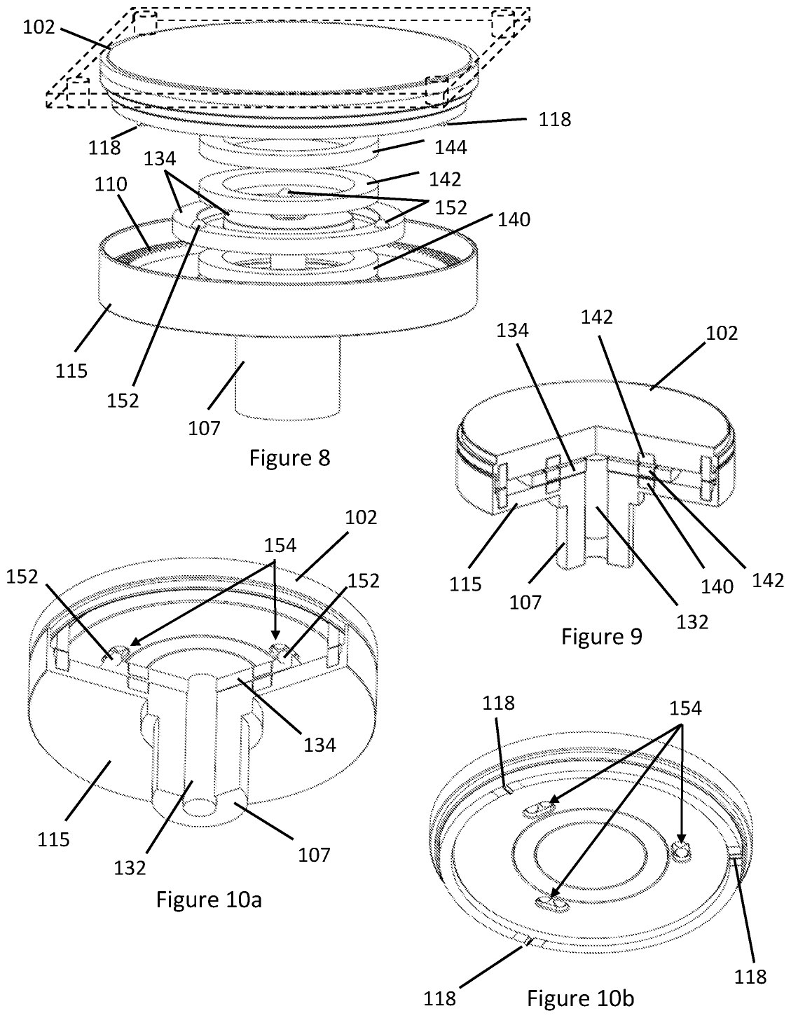

FIG. 8 is an exploded view of the different parts of the indexing and unlocking mechanisms of the indexing head of FIG. 1;

FIGS. 9 and 10a show cut-away views of the different parts of the indexing and unlocking mechanisms of the indexing head of FIG. 1;

FIG. 10b shows the underside of one of the articulated parts of the indexing mechanism of the indexing head of FIG. 1;

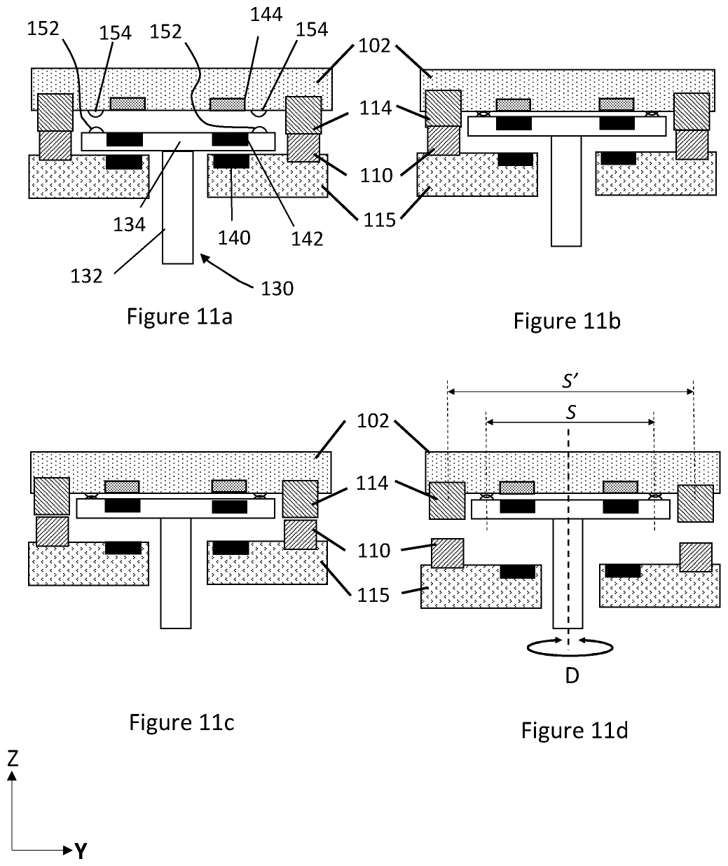

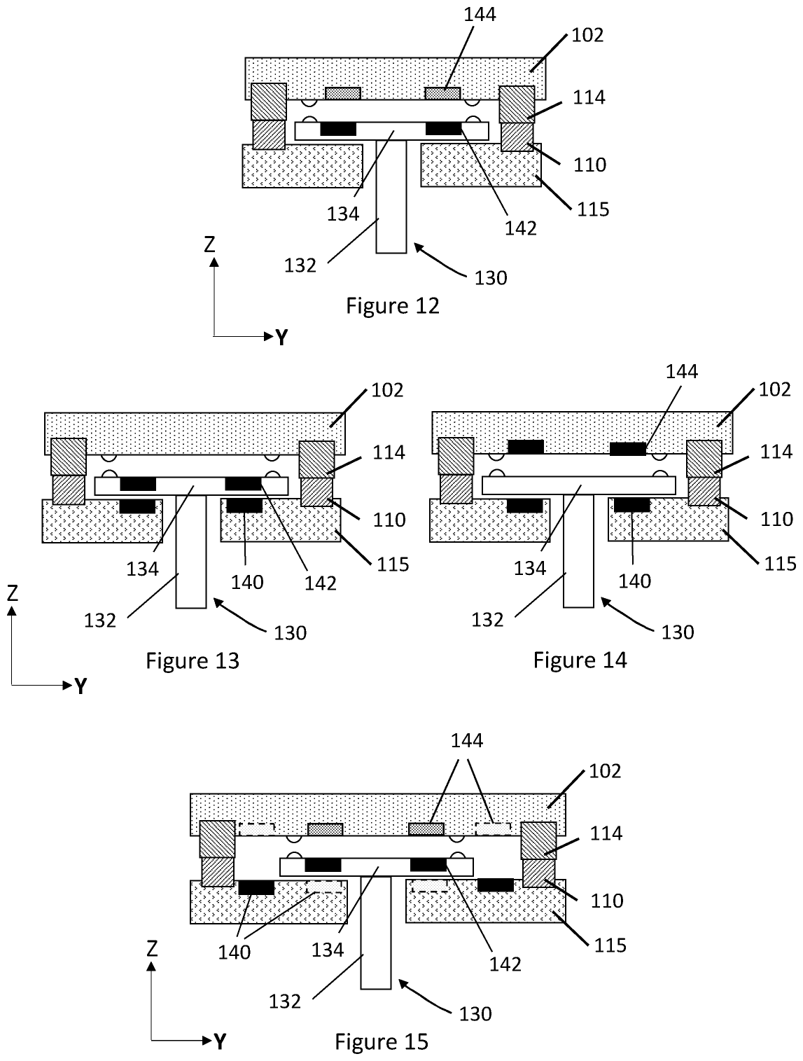

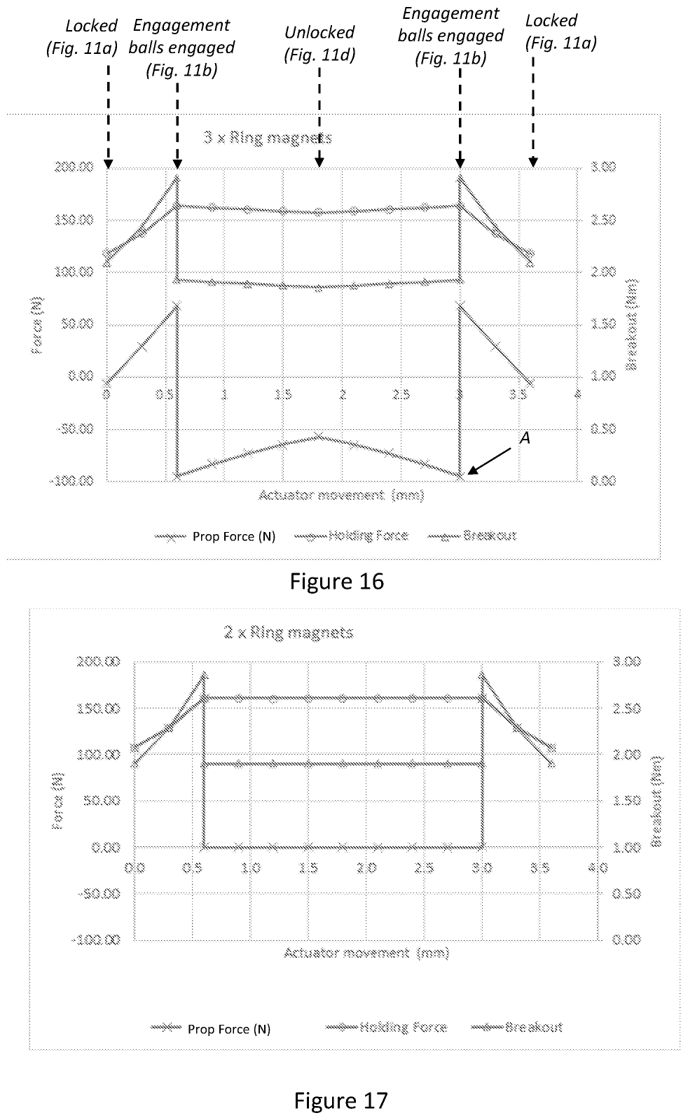

FIGS. 11a to 11d show schematic cross-sectional views of the different parts of the indexing and unlocking mechanisms of the indexing head of FIG. 1 at different stages during an unlocking and locking operation;

FIGS. 12 to 15 show schematic cross-sectional views of the different parts of the indexing and unlocking mechanisms according to alternative embodiments, in particular with different magnet arrangements;

FIG. 16 is a graph illustrating the prop force and holding force for the three ring-magnet embodiment of FIGS. 3, 4 and 11;

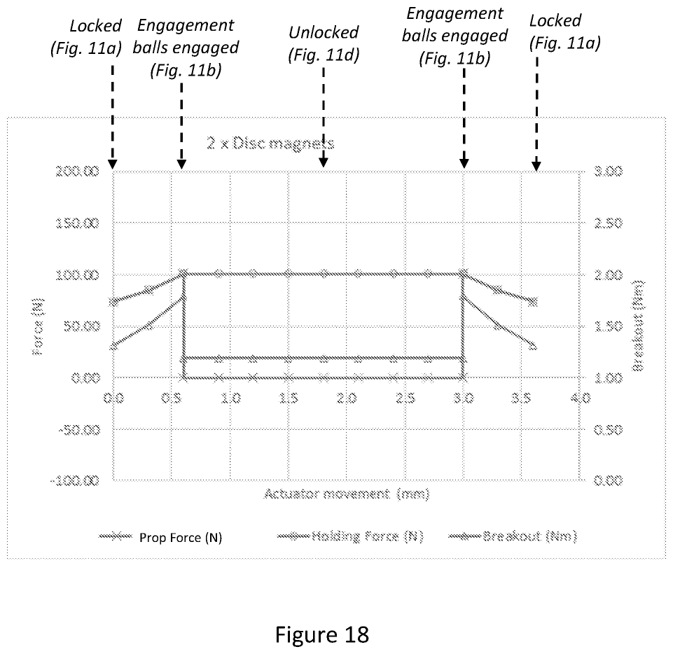

FIG. 17 is a graph illustrating the prop force and holding force for the two ring-magnet embodiment of FIG. 12;

FIG. 18 is a graph illustrating the prop force and breakout torque for a two disc-magnet embodiment; and

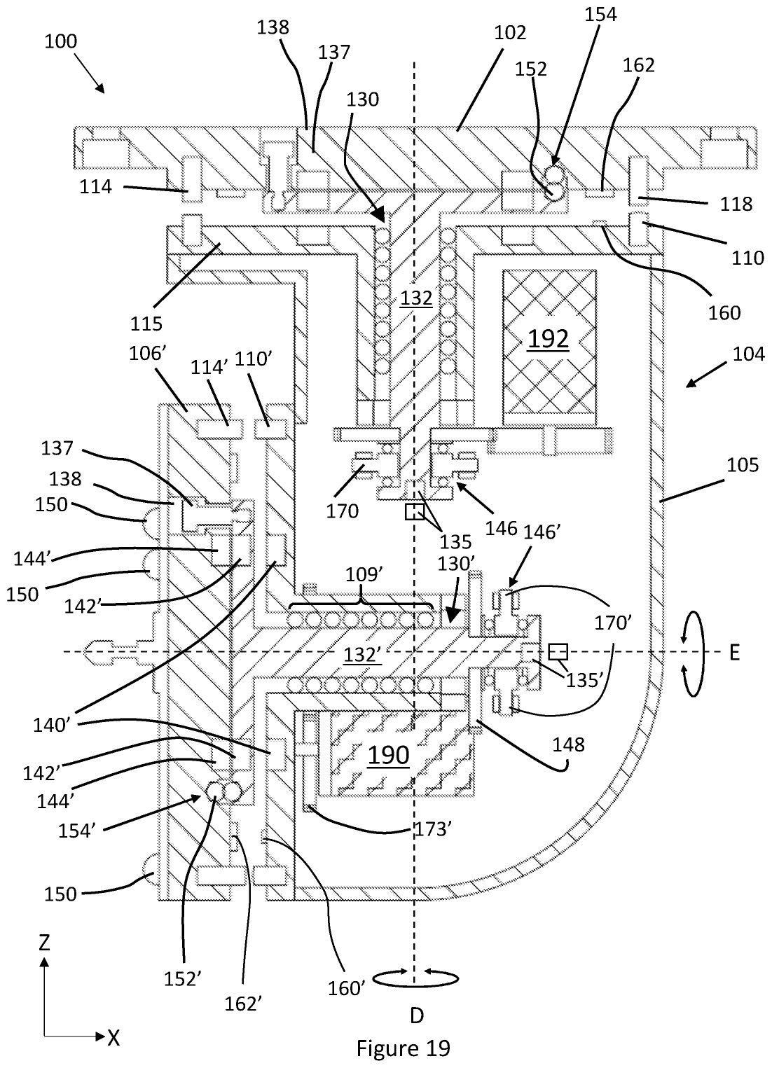

FIG. 19 is a cross-sectional view of the articulated head 100 taken in the Z-X plane with the first axis “D” and the second axis “E” both in unlocked configurations.

With reference to FIG. 1 there is shown an articulated head 100 according to the present invention mounted on a positioning apparatus 200.

The positioning apparatus 200 comprises a movement structure, in this case in the form of a coordinate measuring machine (“CMM”). The CMM 200 comprises a base 202, supporting a frame 204 which in turn holds a carriage 206 which in turn holds a quill 208 (or “Z-column”). Motors (not shown) are provided to move the quill 208 along the three mutually orthogonal axes X, Y and Z (e.g. by moving the frame along the Y axis, and the carriage 206 along the X axis, and the quill 208 along the Z-axis).

The quill 208 holds the articulated head 100, which in turn holds a probe 300. In this embodiment, the articulated head 100 facilitates repositioning of the probe 300 mounted on it, about first and second rotational axes D, E as explained in more detail below.

The combination of the two rotational axes (D, E) provided by the articulated head 100 and the three linear (X, Y, Z) axes of translation of the CMM 200 allows the probe 300 to be moved/positioned in five degrees of freedom (two rotational degrees of freedom, and three linear degrees of freedom).

Although not shown, measurement encoders may be provided for measuring the relative positions of the base 202, frame 204, carriage 206, quill 208 and the parts of the articulated head 100 so that the position of the measurement probe 300 relative to a workpiece located on the base 202 can be determined.

A controller 220 is provided for controlling the operation of the CMM 200, such as controlling the position and orientation of the probe 300 within the CMM volume (either manually, e.g. via an input device such as joystick 216, or automatically, e.g. under the control of an inspection program) and for receiving information (e.g. measurement information) from the CMM 200. A display device 218 can be provided for aiding user interaction with the controller 220. The controller 220 could, for example, be a dedicated electronic control system and/or may comprise a personal computer.

In the embodiment shown, the probe 300 is a contact probe comprising a probe body 302 and a stylus 304. The stylus 304 has a spherical tip 306 for contacting a workpiece to be inspected and in this embodiment the stylus 304 is deflectable relative to the probe body 302. The contact probe 300 could be what is commonly referred to as a touch-trigger probe, or could be a scanning (or analogue) probe. As will be understood, other types of probes including non-contact probes could be mounted on the articulated head 100.

In the current embodiment, the articulated head 100 comprises a probe mount 108 for facilitating the swapping of different probes thereon. In particular, this could be a mount which facilitates auto-changing of probes to and from a rack within the CMM's operating volume. For instance, the probe mount 108 and probe body 302 can comprise magnets for retaining the probe on the mount.

It is possible for the articulated head 100 to comprise built-in sensor componentry for detecting the deflection of the stylus 304 of a contact probe mounted thereon. However, in the present embodiment, all such sensor componentry is provided within the body 302 of the probe 300 itself. The probe 300 is configured to send stylus-deflection signals to the controller 220. As is commonplace, this can be done by a contact signal interface between the probe 300 and probe mount 108, wherein such signals are then relayed to the controller 220 via the articulated head's 100 and CMM's 200 cabling. Such an interface can also be used to supply power to the probe 300. Accordingly, as will be understood, the articulated head 100 will itself have a signal interface with the quill 208 (e.g. one or more corresponding electrical contacts on the articulated head and quill)which can be used to relay probe signals as well as to receive power and motor control instructions so as to control the articulated head 100 (e.g. so as to control the operation of the electrically powered lock 190, 190′ and drive 192, 192′ motors described in more detail below). Accordingly, although not shown for simplicity of illustration, as will be understood, in the embodiments described, the CMM 200 and the articulated head 100 will comprise electrical wires for signals from the articulated head 100 (e.g. probe signals, position information, error messages, etc), and/or for supplying power and instructions to the articulated head 100 (e.g. for controlling the articulated head's motors so as to control the rotational position of the relatively rotatable members). As will be understood, in other embodiments, the articulated head could comprise one or more of its own power sources (e.g. one or more batteries), for powering the articulated head. As will also be understood, in other embodiments, the articulated head could communicate with the controller 220 wirelessly.

Referring now to FIGS. 2 to 19, the articulated head 100 will now be described in more detail.

As shown in FIG. 2, the articulated head 100 comprises a first member 102 or “mounting plate”, a second member 104 which is articulatable/rotatable relative to the first member 102 about a first axis of rotation “D”, and a third member, in this embodiment in the form of a probe arm 106, which is articulatable/rotatable relative to the second member 104 about a second axis of rotation “E”. The second axis of rotation “E” is orthogonal to the first axis of rotation “D”. In the embodiment described, the first axis of rotation “D” is arranged parallel to the CMM's Z-axis, but this need not necessarily be the case.

The first member/mounting plate 102 comprises holes 103 through which bolts can pass so as to fasten the articulated head 100 to the quill 208 of the CMM 200. The probe arm 106 comprises a probe mount 108 on which a probe (such as the contact probe 300) can be interchangeably mounted.

In an alternative embodiment, the probe arm 106 with its probe mount 108 could itself be an interchangeable member. For instance, rather than being a part of the articulated head 100, the probe arm 106 could be provided as part of the probe so that it can be (e.g. automatically) interchanged along with the probe. In this case, the third member of the articulated head 100 could comprise a mount member 106′ for the probe/probe arm 106, the mount member 106′ being articulatable/rotatable relative to the second member 104 about the second axis of rotation “E”. The mount member 106′ and probe arm 106 can be provided with cooperating mounting features, to enable the probe arm 106 to be detachably mounted to the mount member 106′. Such cooperating mounting features could comprise features 150 (see FIG. 19) defining a kinematic mount, for example. One or more magnets could be provided for retaining the probe arm 106 on the mount member 106′.

FIGS. 3 and 4 show a cross-sectional view of the articulated head 100 taken in the Z-Y plane, and FIG. 19 shows a cross-sectional view of the articulated head 100 taken in the Z-X plane. FIGS. 3 and 4 are substantially the same and are common views of the same articulated head, but in FIG. 3 the articulated head 100 is shown with the first member/mounting plate 102 and the second body 105 in their locked state and in FIG. 4 the articulated head 100 is shown with the first member/mounting plate 102 and the second body 105 in their unlocked state. Many reference numerals are omitted from FIG. 4 to aid viewing of the various features of the articulated head 100.

The locking/unlocking, rotating and indexing mechanisms of the first axis “D” and second axis “E” (i.e. of the first member/mounting plate 102 and the second member 104) will now be explained. In this embodiment, the locking/unlocking and indexing mechanism of the second axis “E” (i.e. of the second member 104 and third member 106/106′) is substantially the same (but arranged perpendicular to that of the first axis “D”). Accordingly, in this embodiment, the locking/unlocking, rotating and indexing mechanisms of first “D” and second “E” axes have substantially identical parts. For the sake of brevity and clarity, the description below focusses primarily on the first axis “D”, but as will be understood, much of the description of the first axis “D” is also applicable to the second axis “E”, and the parts of the second axis “E” that are the same as the first axis “D” are labelled in the drawings with the same reference numeral as the first axis “D”, but suffixed with a prime ′ symbol. In accordance with the present invention, the locking/unlocking of the first “D” and second “E” axes can be controlled/actuated independently of each other. In other words, the articulated head could operated so as to unlock the first axis “D” but keep the second axis “E” locked, or vice versa. Of course, if desired, it is still possible to control the articulated head so as to unlock the first “D” and second “E” axis together/simultaneously.

The indexing mechanism of the first axis “D” comprises an arrangement of mutually engageable engagement elements provided on the first member/mounting plate 102 and the second member 104. In particular, there is provided a first annular member 110 having a continuous series of tapered teeth 112 (e.g. see FIGS. 5a and 6 for detailed views). The teeth 112 are substantially radially extending, in that the extent of the teeth predominantly extends along the radial direction (with respect to the radius of the first annular member; and also the first axis “D”). Accordingly, in this embodiment, the first annular member 110 is in the form of a “face spline member” and will subsequently be referred to as such (note that in particular, in the embodiment described, the face spline member has the configuration of a Hirth joint member). The teeth of the face spline member 110 are radially elongate and have a generally tapered cross-sectional profile (taken perpendicular to their length). In this embodiment, each side 111 of a tooth 112 is substantially flat/planar, although this need not necessarily be the case (for instance they could be curved or crowned like the below described crowned tooth 118).

The indexing mechanism/mutually engageable engagement elements further comprises a second annular member 114 which has features configured to intermesh with the teeth 112 of the face spline member 110. The second annular member 114 has features configured to engage only a subset of the continuous series of teeth provided on the face spline member 110 (see FIGS. 5b and 6 for detailed views). Accordingly, instead of the second annular member 114 providing a continuous series of inter-engaging teeth, the second annular member 114 merely comprises features configured to intermesh with the teeth 112 of the face spline member 110 at three discrete, equiangularly-spaced)(120°, locations 116. In this particular embodiment, at each of said locations 116 there is provided a single feature only, in the form of a crowned tooth 118. Each crowned tooth 118 is radially elongate and has a generally tapered profile (taken perpendicular to their length) and thereby provides two curved engagement side surfaces 120 which are configured to engage the side surfaces 111 of the teeth 112 on the face spline member 110.

As illustrated in FIGS. 7a to 7c, the engagement side surfaces 120 of the crowned tooth 118 are curved along their length (in this embodiment along the radial dimension, or along the X-axis as shown in FIGS. 7a and 7c) as well as in their cross-sectional profile (taken perpendicular to their length/radial dimension, as shown in FIG. 7b). Such a configuration (i.e. a crowned tooth 118 which engages flat/planar teeth 112 on the face spline member 110) ensures that each engagement side surface 120 of the crowned tooth 118 presents an apex region 122. It is this apex region 122 which will tend to engage with the side surfaces 111 of the teeth 112 on the face spline member 110. Providing an apex region has been found to provide for more repeatable seating position between the first annular member/face spline member 110 and the second annular member 114. This is because providing the apex region 112 means that for any given pair of teeth on the first annular member/face spline member 110 and the second annular member 114, it is significantly more likely that the teeth in said pair will engage at the same region on their side surfaces 111, 120, each time they come together (compared to if the side surfaces 111, 120 of the teeth on both the first annular member/face spline member 110 and second annular member 114 are both substantially flat/planar), thereby helping to ensure that the first annular member/face spline member 110 and the second annular member 114 seat together in the same position each time they come together at a given angular orientation. In particular, such a configuration helps to provide for a kinematic coupling between the first annular member/face spline member 110 and the second annular member 114.

Furthermore, when the indexing increment becomes small (e.g. smaller than 7.5°, and particularly less than 5°, for instance approaching 2.5°), the described configuration has been found to be significantly advantageous over the balls and rollers indexing mechanism described in WO2006/079794. This is because the smaller the indexing increment, the smaller the intermeshing features are. Not only can it be difficult to accurately manufacture and assemble a ring of balls of having sufficiently smaller diameter, but due to the very small point of contact between balls of very small diameter with corresponding rollers, the Hertzian contact pressure would be extremely high, causing them to be overstressed and this in turn would result in undue wear and/or failure of the indexing mechanism.

For example, in the currently described embodiment, the first annular member/face spline member 110 and second annular member 114 have an outer diameter of 75 mm, and are provided with teeth which are sized so as to provide a 2.5° indexing increment, and the articulated head 100 is configured such that when in the locked position the first annular member/face spline member 110 and second annular member 114 will be held together by a force of approximately 120 N (Newtons). The radius of curvature R′ of the crowned tooth taken in a plane perpendicular to its length (e.g. in the Z-Y plane of FIG. 7b) is 1.8 mm and the radius of curvature R″ of the crowned tooth taken in a plane along its length (e.g. in the Z-X plane of FIG. 7c) is 23 mm. In contrast, if a spherical ball were used in place of the crowned tooth, the ball would have to have a radius of curvature of <0.75 mm in order to fit between the teeth 112 of the first annular member/face spline member. Not only would it be difficult to assemble such small balls into the articulated head, but they would provide an incredibly small contact point, resulting in extremely high Hertzian contact pressure.

As will be understood, the same effect can be achieved by making the teeth 112 on the first annular member/face spline member 110 crowned, and providing the teeth 118 on the second annular member 114 with flat sides, although this can be more difficult to manufacture. Alternatively, the teeth 112, 118 on both the first annular member/face spline member 110 and the second annular member 114 could be crowned, although along with increased manufacturing difficulty, the teeth dimensions would need to be adjusted (in particular increased) in order to avoid undesirable Hertzian contact pressures. In a further alternative embodiment, the indexing mechanism/mutually engageable engagement elements could be provided by an annular arrangement of hemispherical members on one of the parts and three pairs of rollers on the other part, for example as described in U.S. Pat. No. 5,185,936. In another alternative embodiment, the indexing mechanism/mutually engageable engagement elements could comprise a Hirth joint (i.e. both parts comprise Hirth joint/face spline members).

The mechanism for locking and unlocking the indexing mechanism of the first axis “D” will now be described. In summary, in the particular embodiment described, the locking/unlocking mechanism relies solely on magnets to provide the retaining force between the first annular member/face spline member 110 and the second annular member 114 having the crowned teeth 118, and a motor-driven actuator is used to push the first member/mounting plate 102 and the second member 104 away from each other so as to separate the first annular member/face spline member 110 and the second annular member 114 having the crowned teeth 118. This mechanism will be described in more detail immediately below.

In the embodiment described, the locking/unlocking mechanism comprises a trio of stacked magnets. In particular a first 140 ring magnet is provided on the top face 115 of the housing 105 of the second member 104, a second 142 ring magnet is provided on the contact plate 134 of a prop 130 (described in more detail below), and a third magnet 144 is provided on the first member/mounting plate 102. The first 140, second 142 and third 144 ring magnets are identical in shape and size, are stacked so as to be co-axial with each other, and are arranged so that both the first 140 and third 144 ring magnets attract the second magnet 142 which is sandwiched between them. The poles of the ring magnets are axially arranged (i.e. such that the two magnetic poles are on the top and bottom of the flat surfaces of the rings). In particular, the ring magnets are configured such that the north pole of the first magnet 140 faces the south pole of the second 142 magnet, and such that the north pole of the second magnet 142 faces the south pole of the third magnet 144. As explained in more detail below, when in the locked and unlocked positions, the second member 104 is retained solely by magnetic attraction, and in particular solely by the magnetic attractive forces between the third 144, second 142 and first 140 magnets.

The locking/unlocking mechanism comprises a prop 130 which comprises a shaft 132 and a “head” or “contact plate” 134. The shaft 132 of the prop 130 is supported within a linear cylindrical bearing housing 107 provided by the top face 115 member of the housing 105 of the second member 104. A bearing (in this case an array of ball-bearings 109) is provided between the shaft 132 and the cylindrical bearing housing 107 so as to facilitate relative linear and rotational motion between the shaft 132 and the cylindrical bearing housing 107 (i.e. along and about the first axis “D”). The contact plate 134 comprises a radially extending face which is sandwiched between the bodies of the first member/mounting plate 102 and the second member 104.

A motor-driven lever 170 is provided for effecting said linear/axial movement of the shaft 132 along the first axis “D”. The lever 170 is pivotally mounted toward its first end to a flexure 178 which is anchored to the housing 105 of the second member (in this embodiment to the top plate 115) via a mounting block 179. The lever 170 is attached toward its second end to a lead screw mechanism 172 which is configured to raise and lower second end of the lever 170. The lever is attached, at a point between its first and second ends, to the end of shaft 132 that is distal to the contact plate 134 via a bobbin 146 (which facilitates relative rotation of the shaft 132 and lever 170). An electrically powered lock motor 190 is configured to drive the lead screw mechanism 172. In particular, the lock motor 190 is configured to drive a first gear wheel 171 which is configured to engage and turn a second drive gear wheel 173 which turns a lead screw 174. When the lead screw 174 is turned, it causes a nut 176 (which is attached to the lever 170 via a pin 175) to travel axially along the lead screw 174. The lead screw 174 is also anchored to the housing 105 of the second member (in this embodiment to the cylindrical bearing housing 107) via a mounting bracket 177 and bearings 179 such that it can rotate about its axis of rotation, but such that it is fixed relative to the housing 105 of the second member in the Z-dimension (as shown in FIGS. 3 and 4).

It can be advantageous if the drive mechanism for the prop 130 resists back driving (in other words, it is not easily manually back-driven), especially if the three magnet design described below is not adopted. This is because a drive mechanism which is not easily manually back-driven will tend to hold its position even when the motor/power source is not activated if the net external force on the prop 130 is sufficiently low. This can avoid the need to servo the drive mechanism/motor to hold a fixed position and can therefore reduce the power consumption of the articulated head. Accordingly, this can reduce the amount of heat generated by the drive mechanism/motor, which in turn can improve the metrological performance of the articulated head by reducing thermal distortions. A lead screw mechanism with a high gear pitch is one example of a drive mechanism which is not easily back-driven.

As explained in more detail below an electrically powered drive motor 192 is provided which has a gear arrangement (not shown) which is configured to engage and drive a drive gear 148 provided on the shaft 132 towards its end that is distal to the contact plate 134, and can be operated to cause the housing 105 of the first member 104 (and everything anchored to it) to rotate/spin around the shaft 132 about the first axis “D”. A first (or “primary”) rotary encoder device 135 (e.g. a magnetic absolute rotary encoder device) is provided for measuring/monitoring the relative angular position of the housing 105 of the first member 104 and the shaft 132 about the first axis “D”.

The prop's contact plate 134 and the first member/mounting plate 102 have corresponding engagement elements. In particular, the corresponding engagement elements comprise features which are configured to provide a repeatable, and in particular a kinematic, coupling between the prop's contact plate 134 and the first member/mounting plate 102 when engaged. In the embodiment described, the prop's contact plate 134 comprises three engagement balls 152 located 120° apart from each other, and the first member/mounting plate 102 has three pairs of engagement balls 154, the pairs being located 120° apart from each other (see FIG. 10b). Each pair of engagement balls 154 on the first member/mounting plate 102 defines a channel or groove for receiving one of the engagement balls 152 located on the contact plate 134.

As also shown in FIGS. 3 and 4, a second rotary encoder device is provided, which comprises an annular scale 162 provided on the underside of the first member/mounting plate 102 and first 160 and second (not shown) readheads provided on the top face 115 of the housing 105 of the second member 104 (although as will be understood they could be provided the other way around). In the embodiment described, the first 160 and second (not shown) readheads are annularly spaced 90° apart from each other. In the embodiment described, the second rotary encoder device is an incremental optical rotary encoder device. In the particular embodiment described, the second encoder device is a high-resolution encoder which enables the relative position of the first member/mounting plate 102 and the body 105 of the second member 104 to be established within 10 nm (nanometres). Its purpose is described in more detail later on in this document.

The unlocking/reorienting/locking process for the first member/mounting plate 102 and the second member 104 will now be described. FIG. 3 shows the first member/mounting plate 102 and the second member 104 in a locked state. In the locked state a probe 300 mounted on the probe mount 108 can be held in a steady and well-defined angular position such that it can be used in a measurement operation to inspect an artefact. However, it might be desirable to reorient the probe mounted on the probe mount 108, for example for access reasons. To do so it will be necessary to unlock the first member/mounting plate 102 and the second member 104, cause them to be relatively reoriented, and then lock them together at the new orientation.

Unlocking the first member/mounting plate 102 and the second member 104 involves driving the prop 130 axially along the first axis “D” toward the first member/mounting plate 102. In the described embodiment, this is effected by the controller 220 sending an instruction to the articulated head 100 so as to operate the lock motor 190 to drive the lead screw 174 so as to drive the lead screw nut 176 upwards in the Z-dimension (in the orientation shown in FIGS. 3 and 4). In turn, the lever 170 (which is connected to and so is actuated by the lead screw nut 176) pushes the prop's shaft 132 upwards in the Z-dimension (in the orientation shown in FIGS. 3 and 4). After a short distance, the engagement balls 152 on the contact plate 134 of the prop 130 will contact and engage the pairs of engagement balls 154 on the first member/mounting plate 102, after which continued driving of the lead screw 174 will cause the lever 170 and lead screw mechanism 172 to push the housing 105 axially downward (via the cylindrical bearing housing 107 to which the lead screw 174 is anchored), thereby causing the housing 105 of the second member 104 and first member/mounting plate 102 to separate. The lead screw 174 is operated so as to separate the second member 104 and first member/mounting plate 102 by a controlled, predefined amount which is sufficient such that the crowned teeth 118 are clear of the teeth 112, but as explained in more detail below, is not too great because it is desirable that the first magnet 140 remains sufficiently close to the second magnet so as to have a reasonable amount of pull on the second magnet 142 even in the unlocked state. FIG. 4 illustrates the indexing head 100 in such an unlocked state. In accordance with the present invention, the lock motor 190 of the first axis “D” can be operated independently of the electrically powered lock motor 190′ of the second axis “E” such that the second axis “E” can remain locked whilst the first axis “D” is unlocked.

Once the unlocked state has been reached, the lock motor 190 driving the lead screw mechanism 172 is stopped, and the first axis' “D” drive motor 192 which is engaged with the shaft's 132 drive gear 148 is operated in order to effect a change in rotational position of the second member 105 of the articulated head 100. As noted above, in the unlocked state, the prop 130 is engaged with the first member/mounting plate 102 via the engagement balls 152, 154 and so is rotationally fixed with respect thereto (in the unlocked state). Accordingly, when the drive motor 192 which is engaged with the shaft's 132 drive gear 148 is operated, it causes the whole housing 105, 107, 115 of the second member 104 (and all components anchored thereto, which includes the aforesaid motors) to be driven about the shaft 132, and hence causes the whole housing 105, 107, 115 of the second member 104 (and all components anchored thereto) to rotate about the first axis “D”.

The relative rotational position of: i) the housing 105, 107, 115 of the second member 104; and ii) the shaft 132 (and hence the first member/mounting plate 102), is known from the first (“primary”) encoder apparatus 135. Accordingly, the controller 220 can use the output from the first encoder apparatus 135 to control the motor (not shown) engaged with the shaft's drive gear 148 so bring the first member/mounting plate 102 and second member 104 to a desired relative orientation. As will be understood, the rotational position needs to be controlled to a sufficiently high degree of precision such that when in the new desired relative orientation, the crowned teeth 118 on the second annular member 114 sit opposite the valleys of the teeth 112 on the first annular member/face spline member 110, so that when they are locked together the crowned teeth 118 nestle cleanly between two teeth 112 of the first annular member/face spline member 110.

The process of locking the first member/mounting plate 102 and the second member 104 will now be described. In the described embodiment, this is effected by operating the lock motor 190 to drive the lead screw 174 so as to drive the lead screw nut 176 downwards (in the orientation shown in FIGS. 3 and 4). This will cause the housing 105 of the second member 104 to be pulled up toward the first member/mounting plate 102 until the crowned teeth 118 on the second annular member 114 engage the teeth 112 of the face spline member 110, after which continued operation of the lock motor 190 will cause the prop 130 to be retracted away from the first member/mounting plate 102, thereby disengaging the engagement balls 152, 154 provided on the contact plate 134 and the first member/mounting plate 102. Accordingly, at the point of disengagement of the engagement balls 152, 154, the first member/mounting plate 102 and the second member 104 are held via the kinematic constraint provided by the six points of contact between the three crowned teeth 118 and the teeth 112 of the first annular member/face spline member 110.

The way in which the first 140, second 142 and third 144 magnets interact with each other will be described with reference to FIGS. 11a to 11d, which schematically illustrate the prop's shaft 132 and contact plate 134, the second member's top plate 115, the first member/mounting plate 102, the second annular member 114 (which as the three crowned teeth 118), the first annular member/face spline member 110 (which has the continuous series of teeth 112) and the first 140, second 142 and third 144 ring magnets. FIG. 11a illustrates the first member/mounting plate 102 and the second member 104 in a locked position; i.e. in which the teeth 112 on the first annular member/face spline member 110 and the teeth 118 on the second annular member 114 are fully engaged. FIG. 11b illustrates the first member/mounting plate 102 and the second member 104 in a locked position, but at the point where the prop 130 has been actuated to the point where the engagement balls 152 on the contact plate 134 have engaged the engagement balls 154 on the first member/mounting plate 102 and is about to start separating the teeth 112 on the first annular member/face spline member 110 and the teeth 118 on the second annular member 114. FIG. 11c illustrates the first member/mounting plate 102 and the second member 104 in which they have begun to separate, but have not yet reached their fully unlocked configuration. FIG. 11d illustrates the first member/mounting plate 102 and the second member 104 in an unlocked position in which in which the teeth 112 on the first annular member/face spline member 110 and the teeth 118 on the second annular member 114 are fully clear of each other such that the first member/mounting plate 102 and the housing 105 of the second member 104 are free to rotate relative to each other about the first axis “D”.

In the configuration shown in FIG. 11a, the third magnet 144 is attracted to both the second 142 and third 144 magnets, and so thereby pulls the first member/mounting plate 102 toward the prop 130 and the housing 105 of the second member 104. In the embodiment described, the apparatus is configured such that there is a total locking force of approximately 120 N between the first member/mounting plate 102 and the second member 104 when in the locked position (which with appropriate head dimensions, in particular the diameters and locations of the indexing mechanism and of the ring magnets, provides a breakout torque of 2 Nm). As will be understood, the breakout torque is a moment that can be exerted before the first and second bodies start to peel away from each other. This can be important because the articulated head will often be eccentrically loaded. As will also be understood, the breakout torque is dependent on factors other than the retaining/holding/locking force, such as the diameter of the face spline member 110 or the diameter of the ring of engagement balls 152, 154.

In order to transition to an unlocked state, the prop 130 needs to be moved toward the first member/mounting plate 102. Whilst it would seem that the presence of the first magnet 140 would at least initially increase the work required of the lock motor 190 to do so (compared to if it were not present), it should be noted that the apparatus is configured such that in the locked state shown in FIG. 11a, the prop's contact plate 134 is held in a predetermined position which puts the second magnet 142 part-way between the first 140 and third 144 magnets. This ensures that the first magnet's 140 pull on the second magnet 142 is significantly less than it would be if they were to be in contact with each other. Also, the third magnet 144 has a degree of magnetic pull on the second magnet 142. Accordingly, the work/power required to move the second magnet (and hence the contact plate 134) away from the first magnet 140 is significantly less compared to if the first 140 and second 142 magnets were in contact.

In particular, in the embodiment described and shown, the prop's contact plate 134 is held in a predetermined position which puts the second magnet 142 approximately mid-way between the first 140 and third 144 magnets, although such that the second magnet 142 is slightly closer to the first 140 magnet than the third magnet 144. This means that the magnetic forces on the second magnet applied by the first 140 and third 144 magnets is almost (but not quite) balanced. Accordingly, very little work/power is required of the lock motor 190 to move the prop 130 toward the first member/mounting plate 102. Indeed, once the second magnet 142 has reached the mid-way point between the first 140 and third 144 magnets, the magnetic pull of the third magnet 144 on the second magnet 142 will be greater than that of the first magnet 140. As the contact plate 134 progresses toward the first member/mounting plate 102 the magnetic pull of third magnet 144 on the second magnet 142 progressively increases.

When the prop 130 has been moved to the configuration shown in FIG. 11b, it is then necessary for the lock motor 190 to pull the teeth 118 on the body 105/115 of the second member 104 away from the teeth 112 on the first member/mounting plate 102. Whilst there is a sufficiently large holding/retaining force (at least 160 N) holding the second member 104 on the first member/mounting plate 102 (via the engagement balls 152, 154) at this point, the lock motor 190 needs to exert less than the holding/retaining force because it now only needs to exert sufficient force (which in this embodiment is about 95 N) so as to overcome the attractive force between the first magnet's 140 pull on the second 142 and third 144 magnets.

The lock motor 190 continues to drive the prop 130 until the housing 105 of the second member 104 has moved away from the first member/mounting plate 102 by an amount sufficient for the teeth 112 of the first annular member 110 to be clear of the teeth 118 on the second annular member 114, as illustrated in FIG. 11d. At this point, the retaining force holding prop 130 and the housing 105 of the second member 104 onto the first member/mounting plate 102 is approximately 160 N. A higher retaining force is achieved in the configuration shown in FIG. 11d compared to FIG. 11a by controlling the gaps between the first 140, second 142 and third 144 magnets. In particular, despite there being a relatively large gap between the first 140 and second 142 magnets in the unlocked state of FIG. 11d, there is a relatively small gap between the second 142 and third 144 magnets (compared to the gap between the first 140 and second 142 magnets when in the locked state of FIG. 11a) so as to achieve the higher total retaining force. A higher total retaining force is desirable in the unlocked position because the diameters S of the rings of the engagement balls 152, 154 is smaller than the diameters S′ of the first 110 and second 114 annular members, which means that they require a higher pulling/retaining force to ensure the same or similar breakout torque of about 2 Nm (Newton-Metre).

When in the unlocked state shown in FIG. 11d, the first 102 and second 104 members can be relatively rotated about the D axis to a new relative rotational position/orientation. As described above, this involves driving the drive motor 192 (not shown) which engages the shaft's drive gear 148 to cause the body 105 of the second member 104 to rotate around the shaft 132. The output of the first encoder apparatus 135 is used to measure/monitor the relative position of the body 105 of the second member 104 and the shaft 132 (and therefore the first member/contact plate 102, the rotational orientation of which about D is fixed).

When the output of the first encoder apparatus 135 indicates that the body 105 of the second member 104 is now at the desired indexed position, the drive motor 192 is stopped, and the first 102 and second 104 members are locked together as described below.

In order to lock the first 102 and second 104 members in their new rotational position/orientation, the lock motor 190 is operated to drive the lead screw mechanism 172 so as to drive the lead screw nut 176 down the lead screw 174.

This initially causes the housing 105 of the second member 104 to be pulled up toward the first member/mounting plate 102. As will be understood, very little power is required of the lock motor 190 because the housing 105 of the second member 104 is already being pulled toward the first member/mounting plate 102 by the first 140, second 142 and third magnets 144. This continues until the teeth 112 of the first annular member 110 engage the teeth 118 of the second annular member 114 (shown in FIG. 11b) at which point the lock motor 190 and lead screw mechanism 172 has to start pushing against the magnetic forces so as to separate the props' contact plate 134 from the first member/mounting plate 102. However, at this point, the first magnet 140 is much closer to the second magnet 142 and so it exerts a relatively large force on it. Indeed, at this point the net force on the second magnet 142 at the state illustrated in FIG. 11b is only 95 N. Accordingly, the lock motor 190 and lead screw mechanism 172 is assisted by the magnets and can much more easily pull the second magnet 142 (and hence the prop 130) away from the third magnet 144 (and hence the first member/mounting plate 102) until the contact plate 134 reaches the predetermined axial/Z position shown in FIG. 11a.

It is known from the output of the first rotary encoder 135 what indexed rotational position the first member/mounting plate 102 and the second member 104 are at. It can also be useful to check that the first member/mounting plate 102 and the second member 104 have properly locked together. This could be achieved in various ways, for instance by using one or more sensors that can check the separation between the opposing faces of the first member/mounting plate 102 and the second body 105, and if the separation is greater than a fixed threshold amount (which is the same for all indexed positions), then an corrective action can be taken (e.g. an error/warning can be reported and/or action taken to try to remedy the problem such as by attempting an unlock/relock operation, for instance from a different position/direction, and/or demand recalibration).

In the present embodiment described, there is provided a sensor (hereinafter labelled as the “verification” sensor, because it is used to check/verify that the first member/mounting plate 102 and the second body 105 have locked together properly) which is configured to measure and provide information about the relative spatial configuration of first and second bodies in their locked state. The output of the verification sensor is compared to predetermined information associated with the particular indexed position in which they are locked. If the output of the verification sensor differs from the predetermined information by more than a predetermined amount, then such corrective action can be taken.

In the particular embodiment described, the verification sensor, is the above described second rotary encoder device. Accordingly, the outputs of the first 160 and second (not shown) readheads of the second rotary encoder device are used to ensure that the first member/mounting plate 102 and second member 104 have properly locked together. In particular, when locked, the outputs of the first 160 and second (not shown) readheads are passed to electronics 400 within the readhead, which, for example, comprises a processing device 402 (e.g. a CPU (Central Processor Unit), FPGA (Field Programmable Gate Array), or ASIC (Application Specific Integrated Circuit), or the like) and memory 404. The processing device 402 compares the values received from the first 160 and second (not shown) readheads to values stored in a lookup table which resides in the memory 404. In particular, the processing device 402 compares the outputs of the first 160 and second (not shown) readheads to determine whether their outputs are substantially the same as those values stored in the look-up table's element(s) associated with the particular indexed position. If the output of either or both of the first 160 or second (not shown) readhead is substantially different to the values stored in the lookup table (e.g. the difference is greater than 100 nm), then this could be an indication that something is wrong, e.g.: the first member/mounting plate 102 and the second body 105 have not properly locked together; the teeth 112/118 have crashed; there is debris between the teeth 112/118; there is excessive wear between the teeth/118, etc. Accordingly, the apparatus (e.g. the controller) can then take corrective action in such a circumstance. Such correction action could include: causing the first member/mounting plate 102 and the second body 105 to unlock and relock again; outputting a warning signal to an operator and/or other process; halting the current operation, etc.

As mentioned above, the second rotary encoder device is an incremental encoder device. The outputs of the first 160 and second (not shown) readheads therefore do not comprise any absolute position information. Accordingly, rather than comparing absolute position information, the processor 402 compares relative (position) data/information. In particular, for example, as will be understood by those skilled in the art of position measurement encoders, the scale of an incremental position encoder typically comprises an array of regularly spaced features, arranged at a particular spacing, or “period” (which in the described embodiment is 20 μm, but as will be understood scales of other periods can be used). The readhead can read the features (e.g optically, magnetically, inductively, depending on the technology used) and the readhead, or its output, is normally used to “count” the relative position of the readhead and scale as they move relative to each other. It is also well known that the signals received by the readhead and/or output by the readhead can be interpolated to provide a measurement of the relative position of the readhead and scale to a resolution much finer than the actual period of the scale. Such an interpolated reading is often referred to as a “phase” reading. For example, typically quadrature (e.g. SIN and COS) signals are generated from the scale signals and/or are output by a readhead. Such quadrature (e.g. SIN and COS) signals can be interpolated to provide such a “phase” reading. In the embodiment described, it is the interpolated or “phase” reading which is used by the processor 402 and compared with a pre-stored “phase” reading stored in the lookup table's element associated with the particular value.

Accordingly, it is not necessary for the first 160 or second (not shown) readheads to be reading the scale 162 as the first 104 member/mounting plate 102 and the second body 105 move relative to each other as the indexed position is changed (although, if the configuration allows, this can be done). Rather, a single reading can be taken and output by the first 160 and second (not shown) readheads when the lock operation has completed, and the interpolated or “phase” value of those reading can be compared with the pre-stored “phase” readings stored in the lookup table's element associated with the particular value. If either or both of the phase readings differ by more than a predetermined amount (e.g. 100 nm as per the above example), then corrective action could be taken as described above.

Accordingly, the data elements in the look-up table could be said to be a “phase-signature” for each of the calibration indexed positions, and if the values of the phase readings of the first 160 and second (not shown readheads) differ sufficiently from the look-up tables' phase-signature for the given indexed position, then corrective action could be taken.

The lookup table is populated before the articulated head 100 is used for a measuring operation (e.g. could be populated during a calibration procedure). This can comprise the steps of, locking the first 104 member/mounting plate 102 and the second body 105 relative to each other in a given indexed position, and recording/storing the phase readings of the first 160 and second (not shown) readheads in an element/data cell associated with the given indexed position. This is then repeated for each of the articulated head's indexed positions (or at least for the indexed positions in which the head is to be used and for which such verification is desired).

Optionally, the lookup table could be updated over time so as to allow for small degrees of drift over time. This could happen continuously or at regular intervals. This could be done as part of a dedicated calibration process, or it could be done during measurement operations. For example, each time the first member/mounting plate 102 and the second body 105 successfully lock together at any given indexed position (e.g. they pass the above described 100 nm test), the phase reading output by the first 160 and second (not shown) readheads could be stored in the lookup table in place of the previous value.

As will be understood, if desired, the look-up table could be replaced with a function which describes the values in the look-up table. However, a look-up table can be preferred due to its ease of generation and because it is easy to keep it up to date.

As will be understood, rather than two readheads, a single readhead could be used, or more than two readheads could be used. It is not necessary for multiple readheads to be placed 90° apart from each other around the scale 162. However, it has been found that providing multiple readheads which are not diametrically opposite each other (i.e. not at 180°) is particularly advantageous because it can provide information about the spatial configuration of the first member/mounting plate 102 and the second body 105 in multiple dimensions, and providing them at substantially/approximately 90° C. an be preferred for reasons of efficiency and optimum performance.

The second rotary encoder device described above is an incremental encoder, but as will be understood, it could instead by an absolute encoder device.

In the above-described embodiment, the verification sensor, is a rotary encoder device. However, it need not necessarily by the case. Other types of sensor could be used, such as, for example, a position sensitive device (PSD) the output of which is dependent on the relative spatial position of the first member/mounting plate 102 and the second body 105 when locked together. In this case, a lookup table could be populated during a calibration stage so as to record the output of the PSD for each of the indexed positions of interest (e.g. which could be all indexed positions or only those which are intended to be used during a subsequent measurement operation). Subsequently, in use, when the first member/mounting plate 102 and the second body 105 are locked in particular indexed position, the PSD can provide an output to the processor 402 which is then compared to the value stored in the particular element of the lookup table stored in memory 404 which is associated with the particular indexed position. If the output of the PSD differs by more than a threshold amount, then corrective action can be taken.

In an alternative embodiment, the verification sensor is configured to measure just the relative height/separations of the first and second bodies (e.g. via a capacitive sensor). However, advantageously, when the first and second bodies are locked together, the output of the verification sensor is compared to a pre-stored value in the element of the look-up table which is associated with the particular indexed position at which the first and second bodies are locked together.

As will be understood, further variations and alternative embodiments of the articulated joint described above are possible. For instance, one or two of the first 140, second 142 and third 144 magnets could be replaced with magnetically attractable (e.g. ferrous) material. This would provide a similar, albeit weaker, effect to that providing three magnets. Accordingly, the one or two magnets that remain would need to be stronger, and therefore bigger, which could also (depending on the configuration) mean that a larger peak motor force is needed.

In another similar embodiment, the first magnet 140 is located elsewhere. For example, the first magnet 140 could be located at/toward the end of the shaft 132 which is distal to the contact plate 134. Again, this would provide a similar effect in terms of aiding the lock motor 190 during the locking/unlocking processes, but because the first magnet 140 is located far away from the first member/mounting plate 102 it would provide little if any retaining force, and so it would be necessary to provide bigger/stronger second 142 and/or third 144 magnets.

FIG. 12 schematically illustrates an alternative embodiment in which the first magnet 140 is omitted such that the second member 104 is magnetically retained on the first member/mounting plate 102 by just a pair of magnets, i.e. the third magnet 144 provided on the first member/mounting plate 102 and the second magnet 142 provided on the contact plate 134 of the prop 132. Whilst this is possible, the second 142 and third 144 magnets need to provide all the locking/retaining force themselves, and so either one or both of them will need to be much stronger than the triple magnet arrangement described above, which then will require the lock motor 190 to work much harder during the locking process when the prop's contact plate 134 is to be pulled away from the first member/mounting plate 102 (i.e. at the transition from FIG. 11b to FIG. 11a). Also, without the first magnet 140, all forces which retain the housing 105 of the second member 104 to the first member/mounting plate 102 have to be carried through the prop 130, lever 170, and lead screw mechanism 172 and associated bearings. This would require those parts to be bigger/stronger and would ideally need a motor which prevents back-driving.

FIG. 13 illustrates another alternative embodiment in which the third magnet 144 is omitted such that the second member 104 is magnetically retained on the first member/mounting plate 102 by just a pair of magnets, i.e. the first magnet 140 provided on the housing's top plate 115 and the second magnet 142 provided on the prop's contact plate 134. In this case, the first member/mounting plate 102 (at least a part thereof) has to be made from material capable of being attracted by a magnet (e.g. ferrous material). A disadvantage of this embodiment is that the holding/retaining and breakout torques are lower compared to if the third magnet was present (and so bigger/stronger first 140 and/or second 142 magnets are required if the same holding/retaining and breakout torques are desired).

FIG. 14 illustrates another alternative embodiment in which the second magnet 144 is omitted such that the second member 104 is magnetically retained on the first member/mounting plate 102 by just a pair of magnets, i.e. the first magnet 140 provided on the housing's top plate 115 and the third magnet 144 provided on the first member/mounting plate 102. A disadvantage of this embodiment is that the holding/retaining and breakout torques are lower compared to if the second magnet was present (and so bigger/stronger first 140 and/or third 144 magnets are required if the same holding/retaining and breakout torques are desired). In this embodiment, the contact plate 134 could comprise material capable of being attracted by a magnet (e.g. ferrous material) so as to aid magnetic retention, but this is not as good as the contact plate 134 comprising a magnet.

FIG. 15 illustrates another alternative embodiment. In this embodiment, it is illustrated that it is not essential for the magnets to be stacked directly such that they are in-line with each other. For example, FIG. 15 illustrates alternative locations of the first 140 and/or third 144 magnets 140, (e.g. they could be located radially further out than the second 142 magnet).

It is also possible for magnets to be used in an arrangement in which they repel each other in order to provide the necessary locking/retaining forces.

However, it has been found that the described arrangement of having at least three, in-line, stacked magnets, all arranged to attract each other, as per the embodiment of FIGS. 1 to 11, can be advantageous. In particular, it has been found to significantly reduce the work require of the lock motor 190 which controls the linear position of the prop 130 when it is in its locked state, as well as can help to reduce the peak work required of the lock motor 190 during the locking action. Not only can this reduce the size of the lock motor 190 required and help to keep the articulated head compact and light, but it can also reduce the heat output of the lock motor 190 (which in turn can improve the metrological performance of the articulated head by reducing/avoiding thermal distortions). Indeed, whilst the magnets of the embodiment of FIGS. 1 to 11 can be configured to provide 120 N of pull force when locked and 160 N when unlocked (so as to provide a 2 Nm breakout torque), due to the three, in-line, stacked magnets, the lock motor 190 only needs to produce a peak 95 N of force.

FIG. 16 is a graph illustrating the prop force and holding force for the three magnet embodiment of FIGS. 3, 4 and 11 and FIG. 17 is a graph illustrating the prop force and holding force for the two magnet embodiment of FIG. 12 (which is equivalent in every aspect apart from that the first magnet 140 has been omitted). The holding force (also referring to above as the “retaining force” or “locking force”) is net force which pulls the first member 102 and second member 104 together. The prop force is the net magnetic force experienced by/exerted on the prop 130. Accordingly, this is the magnetic force that has to be overcome in order to hold the prop 130 at position. Such force can be overcome by a combination of the force exerted on the prop by the lock motor 190 and any friction in the gearing/motor/prop system (as will be understood, if friction in the gearing/motor/prop system is excluded, then the prop force is proportional to the work required of the lock motor 190; e.g. proportional to the motor current).

As shown in FIG. 16, when the first member/mounting plate 102 and second member 104 are in their locked state, the prop force is very low (less than 10 N). Accordingly, the force required to hold the prop 130 in position is low. Indeed, it is so low that depending on the gearing/motor/prop system, friction might be sufficient to hold the prop 130 in position (e.g. if it is highly resistant to back-driving). Accordingly, very little to zero motor power is required to hold the prop 130 in position. Furthermore, as described above, the configuration of FIGS. 1 to 11, is arranged such that in the locked position the prop 130 is positioned such that the magnetic force biasing the second magnet 142 toward the first magnet 140 is greater than the magnetic force biasing the second magnet 142 toward the third magnet 144. Accordingly, even if the lock motor 190 controlling the linear position of the prop 130 was turned off, and even if friction is not sufficient to hold the prop 130 in place against the magnetic bias, all that will happen is that the prop 130 will retract further until the contact plate 134 abuts the housing top face 115, which will have no detrimental impact on the engagement of the teeth 112, 118 of the first member/mounting plate 102 and second member 104.

This is to be contrasted with the prop force experienced by the prop 130 in the two-magnet embodiment of FIG. 12. As illustrated in FIG. 17, when in the locked state (which is the stated illustrated in FIG. 12), there is a significant net magnetic force which is biasing the second 142 magnet toward the third magnet 144 (about 110 N). Accordingly, in the locked position, significant work/power is required of the lock motor 190 to hold the prop 130 in position. Indeed, the prop force is so great that even the friction of the lead-screw mechanism which is highly resistant to back-driving is not sufficient to overcome the prop force and so if the lock motor 190 was powered off the prop 130 would creep toward the first member/mounting plate 102 until they come into contact which would then interfere with the engagement of the teeth 112, 118 of the first member/mounting plate 102 and second member 104.

As can be seen from the graphs in FIGS. 16 and 17, there is some disadvantage to the three-magnet embodiment, in that there is significant prop force when the prop 130 and the first member/mounting plate 102 are engaged. Accordingly, significant motor work/power is required to push against the prop force so as to separate the first member/mounting plate 102 and the second body 104 (e.g. between the states shown in FIGS. 11b and 11d), and also to hold the first member/mounting plate 102 and the second body 104 in their unlocked state (e.g. in the state shown in FIG. 11d). In contrast, with the two-magnet embodiment of FIG. 12, there is zero prop force so very little motor work/power is required to separate the first member/mounting plate 102 and the second body 104 once the prop 130 and the first member/mounting plate 102 have engaged.

However, under normal circumstances, the amount of time that the articulated head spends in its unlocked state is significantly less than the amount of time that the articulated head spends in its locked state, and so the benefit of the three-magnet embodiment needing significantly less (or even zero) motor power in the locked state outweighs the cost of needing to work harder in the unlocked state.

The three-magnet embodiment of FIGS. 1 to 11 also has the benefit that the peak motor work/power required of the lock motor 190 is less than that of the two-magnet embodiment. In the two-magnet embodiment, the greatest amount of work required of the lock motor 190 is when it is re-locking the first member/mounting plate 102 and the second body 104, and in particular the peak motor work/power is required at the point the teeth 112, 118 of the first member/mounting plate 102 and the second body 104 engage and the lock motor 190 is trying to separate the prop's contact plate 134 and the first member/mounting plate 102. At this point, the lock motor 190 has to overcome the attractive pull of second 142 and third 144 magnets all by itself (as well as overcome any friction in the gearing/motor/prop system), and so needs to exert a force greater than 150 N. In contrast, with the three-magnet embodiment, at the point the teeth 112, 118 of the first member/mounting plate 102 and the second body 104 engage and the lock motor 190 is trying to separate the prop's contact plate 134 and the first member/mounting plate 102 during a locking operation (i.e. at point represented by FIG. 11b), the first 140 and second 142 magnet have been brought closer together (compared to when they were fully unlocked as shown in FIG. 11d). Accordingly, the first magnet 140 is close enough to the second magnet 142 to exert a significant amount of pull on the second magnet 142 and so assists the lock motor 190 in separating the separate the prop's contact plate 134 and the first member/mounting plate 102. This results in the lock motor 190 only needing to exert about 95 N to effect such separation (see point A in FIG. 16).

As will be understood, alternative means could be provided for retaining the first member/mounting plate 102 and second member 104 and/or for retaining the third member 106/106′ and second member 104. For instance, mechanical springs could be used to pull the housing 105 of the second member 104 and the first member/mounting plate 102 together and/or mechanical springs could be used to pull the third member 106/106′ and second member 104 together. However, it has been found that magnets can be preferred over such mechanical solutions due to possible issues with hysteresis caused by friction (magnets can avoid the need for any moving parts between the first member/mounting plate 102 and the second member 104, and/or between the third member 106/106′ and second member 104). In another embodiment, one or more mechanical rods (such as those described in U.S. Pat. No. 7,213,344) could be used to pull the housing 105 of the second member 104 and the first member/mounting plate 102 together (i.e. so as to be able to lock/unlock the D axis), and/or mechanical rods (again, such as those described in U.S. Pat. No. 7,213,344) could be used to pull the third member 106/106′ and the housing 105 of the second member 104 together (i.e. so as to be able to lock/unlock the E axis). However, in contrast to U.S. Pat. No. 7,213,344, and in accordance with the present invention, the rods for the different axes would need to be independently operable so that the different axes (D, E) can be locked/unlocked independently. For instance, separate motors could be provided; one for each of the rods for the different axes, which can be independently operated so as to independently drive the rods.

Advantageously, the above embodiment relies on the use of ring magnets. It is possible that one or more of the ring magnets could be replaced by disc magnets, but, somewhat counterintuitively, the inventors have identified that ring magnets have a substantially different force/distance profile compared to disc magnets which can be significantly advantageous in the present situation (and in particular ring magnets appear to provide a more efficient design for a given surface area compared to disc magnets). Indeed, it has been found that in this configuration, ring magnets can provide a much greater force (around 50% more) than a disc magnet of the same outer diameter and depth (measured orthogonal to the diameter of the ring). FIG. 18 is a graph illustrating the prop force and breakout torque for a two disc-magnet embodiment, which is equivalent in every aspect to that shown in FIG. 12 apart from that the second 142 and third 144 magnets are disc magnets instead of ring (wherein the outer-diameter of the disc magnets are the same as the outer-diameter of the ring magnets). As shown, the prop force, and crucially the breakout torque, is significantly less than the equivalent ring-magnet embodiment.

This finding has enabled them to provide the articulated head with a very high retaining/locking force which in turn enables higher loads/higher moments to be carried by the articulated head before the magnetic coupling fails. For example, it might be desirable to carry very heavy probes such as camera/video probes and/or it might be desirable to carry very long stylus which provide a large moment on the magnetic coupling, especially during probing. The need for such large forces has in the past pushed designers of articulated heads which are suitable for carrying large loads/moments, away from the use of magnets. For example, the articulated heads disclosed in US7263780 and US9494403 use mechanical rods to provide the locking force. However, the inventors found that the use of ring magnets can provide a suitably large retaining load without needing physically large magnets and therefore can be fitted appropriately into an articulated head which is to be mounted onto a positioning apparatus such as a CMM.

As an alternative to continuous ring magnets, a series of small disc magnets arranged in a ring shape can provide advantages over a single disc magnet having the same diameter as the ring shape, but it has been found that a continuous ring provides the most efficient design (for a given surface area).

As described above, the planar teeth 112 of the first annular member/face spline member 110 and the crowned teeth 118 of the second annular member 114 provide for stable and repeatable positioning of the first member/mounting plate 102 and the second member 104. When in the locked state, the only physical/mechanical constraints between the first member/face spline member 102 and the second member 104 are the points of contact between planar teeth 112 of the first annular member/face spline member 110 and the crowned teeth 118 of the second annular member 114. It is a particular advantage of this configuration that at each of the indexed positions, the second member 104 is constrained in all six degrees of freedom with respect to the first member/mounting plate 102 by the six points of contact provided by the crowned teeth 118 of the second annular member 114 and the planar teeth 112 of the first annular member/face spline member 110, thereby providing a kinematic constraint. This is true for each of the possible indexed positions. This provides for maximum positional repeatability of a probe 300 mounted on the articulated head 100 at each indexed position. It is also advantageous that the face spline member 110 and second annular member 114 have the dual function of being both indexing elements and retaining elements.

As can be seen in FIGS. 3, 4 and 19 a safety catch 136 or “pin” is provided. The safety catch 136 is provided merely to act as a safety mechanism to prevent complete detachment of the first 102 and second 104 members should the magnetic retaining mechanism fail (e.g. due to overloading of the second member 104, for instance due to a crash). One end of the safety catch 136 is secured to the prop's contact plate 134 and the other “head” end sits loose within a void 138 in the first member/mounting plate 102. Due to it sitting loose with a void in the first member/mounting plate 102, it does not act as a constraint between the first member/mounting plate 102 and the prop 130/the second member 104 (and therefore does not interfere with the above described kinematic coupling of the first member/mounting plate 102 and the second member 104 when in the locked configuration, nor interfere with the kinematic coupling of the first member/mounting plate 102 and the prop 130 when in the unlocked configuration). However, the safety catch 136 has an enlarged head member 137 which in the event of a failure of the magnetic coupling between the second 142 and third 144 magnetic rings, will engage a ledge 139 in the void, thereby preventing further separation of the first member/mounting plate 102 and the second member 104.

In the embodiments described above, the face spline member 110 is provided on the articulated head's second member 104, and the crowned teeth 118 are provided on the first member/mounting plate 102. However, this need not necessarily be the case and they could be provided the other way around.

In the embodiments described above, the first member/mounting plate 102 and second member 104 are magnetically retained, via an arrangement of magnets which has meant that it is not necessary to use a mechanical means (e.g. arms/levers) for pulling and holding the first member/mounting plate 102 and the second member 104 together. Accordingly, when in the locked state, the only mechanical constraint between the first member/mounting plate 102 and second member 104 is provided by the teeth of the face spline member 110 and the teeth of the second annular member 114. Therefore, when in the locked configuration, the prop 130 is decoupled from the first member/mounting plate 102 such that the prop 130 does not interfere with the above-described kinematic coupling of the first member/mounting plate 102 and the second member 104. However, this need not necessarily be the case. For instance, in other embodiments, a mechanical push/pull lever arm mechanism could be provided, wherein one end of the arm is encapsulated within a bearing of the first member/mounting plate 102 and the other end of the arm is encapsulated within a bearing of the second member 104.

The unlocking and locking of the first axis “D” is described above in detail. In the embodiment the locking/unlocking and indexing mechanism of the second axis “E” (i.e. of the second member 104 and third member 106/106′) is substantially the same as the first axis “D”, and so the above description for the first axis “D” also applies to the second axis “E”. Accordingly, in summary, similar to the first axis “D” described above, the controller 220 can send an instruction to the articulated head 100 so as to operate the lock motor 190′ of the second axis “E” so as to drive a lead screw (not shown) to thereby drive a lead screw nut 176′ horizontally in the X-dimension (in the orientation shown in FIG. 19). In turn, the lever 170′ (which is connected to and so it actuated by the lead screw nut 176′) pushes the prop's shaft 132 upwards in the Z-dimension (in the orientation shown in FIGS. 3 and 4) After a short distance, the engagement balls 152′ on the contact plate 134′ of the prop 130′ will contact and engage the pairs of engagement balls 154′ on the third member 106/106′, after which continued driving of the lead screw 174′ will cause the lever 170′ and lead screw mechanism 172′ to push the third member 106/106′ axially outwards, thereby causing the housing 105 of the second member 104 and third member 106/106′ to separate. The lead screw 174′ is operated so as to separate the second member 104 and third member 106/106′ by a controlled, predefined amount which is sufficient such that the crowned teeth 118′ of the third member 106/106′ are clear of the mating teeth 112′ on the second member 104, but as explained above in connection with the first axis “D”, is not too great because it is desirable that the first magnet 140′ remains sufficiently close to the second magnet 142′ so as to have a reasonable amount of pull on the second magnet 142′ even in the unlocked state. FIG. 19 illustrates the second axis “E” of the articulated head 100 in such an unlocked state.

Once the unlocked state has been reached, the lock motor 190′ driving the lead screw mechanism 172′ is stopped, and the second axis' “E” electrically powered drive motor 192′ which is engaged with the shaft's 132′ drive gear 148′ is operated in order to effect a change in rotational position of the third member 106/106′ relative to the second member 105. In the unlocked state, the prop 130′ is engaged with the third member 106/106′ via the engagement balls 152′, 154′ and so is rotationally fixed with respect thereto (in the unlocked state). Accordingly, when the second axis' “E” drive motor 192′ which is engaged with the shaft's 132′ drive gear 148′ is operated, it causes the third member 106/106′ to be driven about the axis of rotation E defined by the shaft 132′.

The relative rotational position of: i) the housing 105, 107, 115 of the second member 104; and ii) the second axis' “E” shaft 132′ (and hence the third member 106/106′), is known from the second axis' “E” first (“primary”) encoder apparatus 135′. Accordingly, the controller 220 can use the output from the second axis' “E” first encoder apparatus 135′ to control the second axis' “E” drive motor 192′ engaged with the shaft's drive gear 148′ so bring the second member 104 and the third member 106/106′ to a desired relative orientation. As will be understood, the rotational position needs to be controlled to a sufficiently high degree of precision such that when in the new desired relative orientation, the crowned teeth 118′ on the third member 106/106′ sit opposite the valleys of the teeth 112 on the second axis' “E” annular member/face spline member 110′, so that when they are locked together the crowned teeth 118′ nestle cleanly between two teeth 112′ of the second axis' “E” annular member/face spline member 110′.

As with the first axis “D”, first 140′, second 142′ and third 144′ magnets are provided on the housing 105 of the second member 104, prop 130′ and third member 106/106′ of the second axis “E” and so benefit from the magnetically assisted unlocking and locking arrangement of the first axis “D”. Also, as with the first axis “D”, a second rotary encoder device is provided for the second axis “E”, which comprises an annular scale 162′ provided on the third member 106/106′, and first 160′ and second (not shown) readheads provided on the housing 105 of the second member 104, and can be used in the same manner as that described above in connection with the first axis “D” for checking that the second member 104 and the third member 106/106′ have properly locked together. Furthermore, the indexing mechanism of the second axis “E” is similar to that of the first axis “D”, in that it comprises a first annular member 110′ having a continuous series of tapered teeth which are substantially radially extending (e.g. it is in the form of a “face spline member”) and a second annular member 114′ which has three crowned teeth configured to engage the continuous series of teeth provided on the face spline member 110′ at three equiangularly-spaced locations.

In the above-described embodiments, separate lock motors are provided for the first axis “D” and second axis “E”. However, this need not necessarily be the case. For example, one “lock” motor could be provided, and means for selecting which of the axes it causes to separate could be provided. For example, a system of gears, e.g. a gear-box, could be provided and configured such that the motor can be selected so as to control the locking/unlocking of just the first axis “D”, or selected so as to control the locking/unlocking of just the second axis “E”, or selected so as to control the locking/unlocking of both the first axis “D” and second axis “E” together. However, it can be preferred to use separate motors for simplicity and because if just one motor were provided it would need to be sufficiently large/powerful enough so as to cope with unlocking both axes at the same time when required. Similarly, in the above-described embodiments, separate drive motors are provided for the first axis “D” and second axis “E”. However, this need not necessarily be the case. For example, one “drive” motor could be provided, and means (e.g. a gear-box) for selecting which of the axes it causes to drive could be provided). Again, separate drive motors can be preferred. The above describes a two-axis articulated head. However, as will be understood, the invention is not limited to a two axis articulated heads. For example, the articulated head could be a three-axis articulated head wherein there is provided a fourth member coupled to the third member such that its orientation relative to the third member about a third axis can be changed (e.g. changed between, and locked at one of, a plurality of predefined indexable orientations). In such a case, the above-described features can be applicable to the third and fourth members, as appropriate. The first, second and third axes could be mutually orthogonal. In such a case, the fourth member can comprise the tool mount for receiving a tool. In such a case, the first, second and third axes of rotation could be mutually orthogonal.

1. An articulated head for facilitating the reorientation of a tool mounted thereon, the articulated head comprising:
a first member for mounting the articulated head on a positioning apparatus;
a second member coupled to the first member such that its orientation relative to the first member about a first axis can be changed between, and locked at one of, a plurality of predefined indexable orientations, wherein the first member and second member can be unlocked by separating the first member and second member along the first axis so as to thereby enable reorientation of the second member relative to the first member about the first axis;
a third member coupled to the second member such that its orientation relative to the second member about a second axis can be changed between, and locked at one of, a plurality of predefined indexable orientations, wherein the second member and third member can be unlocked by separating the second member and third member along the second axis so as to thereby enable reorientation of the third member relative to the second member about the second axis, wherein the first and second axis are not parallel; and
at least one powered mechanism for controlling the separation of the first member and second member along the first axis and the separation of the second member and third member along the second axis, configured such that the separation of the first member and second member, and the separation of the second member and third member, can be controlled independently of each other.

2. An articulated head as claimed in claim 1, wherein the at least one powered mechanism comprises a first lock motor for controlling the separation of the first member and second member along the first axis, and a second lock motor for controlling the separation of the second member and third member along the second axis, the first and second lock motors being independently operable.

3. An articulated head as claimed in claim 1, wherein the first and second lock motors are housed within the second member.

4. An articulated head as claimed in claim 1, comprising a first drive motor for effecting reorientation of the second member relative to the first member about the first axis when the first member and the second member are unlocked, and a second drive motor for effecting reorientation of the third member relative to the second member about the second axis when the second and third members are unlocked.

5. An articulated head as claimed in claim 3, wherein the first and second motors and/or the first and second drive motors comprise electric motors.

6. An articulated head as claimed in claim 1, wherein the third member comprises a mount for receiving a tool.

7. An articulated head as claimed in claim 1, wherein the first member and second member provide a first pair of cooperating sets of mutually engageable engagement elements which can be locked together in a plurality of different angular orientations about the first axis so as to provide the predefined indexable orientations, and in which the second member and third member provide a second pair of cooperating sets of mutually engageable engagement elements which can be locked together in a plurality of different angular orientations about the second axis so as to provide the predefined indexable orientations.

8. An articulated head as claimed in claim 1, comprising a first prop which is actuatable by the at least one powered mechanism between a retracted configuration at which the first member and second member are in their locked state, and an extended configuration at which the first member and the second member are held apart by the first prop along the first axis such that the first member and second member are unlocked, and a second prop which is actuatable by the at least one powered mechanism between a retracted configuration at which the second member and the third member are in their locked state, and an extended configuration at which the second member and the third member are held apart by the second prop along the second axis such that the second and third members are unlocked.

9. An articulated head as claimed in claim 8, wherein the first prop is axially driven between its extended and retracted configurations by a first lever which is actuated by the at least one powered mechanism, and/or the second prop is axially driven between its extended and retracted configurations by a second lever which is actuated by the at least one powered mechanism.

10. An articulated head as claimed in claim 9, wherein the first lever is pivotally mounted toward its first end to a first flexure which is anchored to the second member, and attached toward its second end to the at least one powered mechanism which is configured to raise and lower second end of the first lever, and is attached at a point between its first and second ends to the first prop, and wherein the second lever is pivotally mounted toward its first end to a second flexure which is anchored to the second member, and attached toward its second end to the at least one powered mechanism which is configured to raise and lower second end of the first lever, and is attached at a point between its first and second ends to the second prop.

11. An articulated head as claimed in claim 8, wherein the first prop and the first member are magnetically biased toward each other, and in which the second prop and the third member are magnetically biased toward each other.

12. An articulated head as claimed in claim 11, further comprising at least one supplemental bias member configured to bias the first prop towards its retracted configuration, and configured to bias the second prop towards its retracted configuration.

13. An articulated head as claimed in claim 12, in which the at least one supplemental bias member comprises magnetic material, for example a magnet.

14. An articulated head as claimed in claim 13, in which the first prop, the first member and the second member comprise magnetic material arranged so as to provide:
i) magnetic forces acting on the first prop which urge the first prop toward its extended configuration; and
ii) magnetic forces acting on the first prop which urge the first prop toward its retracted configuration.

15. An articulated head as claimed in claim 13, in which the second prop, the second member and the third member comprise magnetic material arranged so as to provide:
i) magnetic forces acting on the second prop which urge the second prop toward its extended configuration; and
ii) magnetic forces acting on the second prop which urge the second prop toward its retracted configuration.

16. A positioning apparatus comprising mounted thereon an articulated head as claimed in claim 1.

17. A method of operating an articulated head as claimed in claim 1 which is mounted on a positioning apparatus, the method comprising:
i) operating the at least one powered mechanism so as to cause unlocking of the first and second members whilst keeping the second and third members locked, relatively rotating the first and second members about the first axis to a new rotational position, and then operating the at least one powered mechanism so as to cause locking of the first and second members at the new rotational position; or
ii) operating the at least one powered mechanism so as to cause unlocking of the second and third members whilst keeping the first and members locked, relatively rotating the second and third members about the second axis to a new rotational position, and then operating the at least one powered mechanism so as to cause locking of the second and third members at the new rotational position.
